(19) United States
(12) Patent Application Publication
(10) Pub. No.: US 2018/0031603 A1
(43) Pub. Date: Feb. 1, 2018

(54) SYSTEMS AND METHODS FOR DETECTING INERTIAL PARAMETERS USING A VIBRATORY ACCELEROMETER WITH MULTIPLE DEGREES OF FREEDOM

(71) Applicant: Lumedyne Technologies Incorporated, San Diego, CA (US)

(72) Inventors: Xiaojun Huang, San Diego, CA (US); Ozan Anac, Oakland, CA (US); Mehmet Akgul, Mountain View, CA (US)

(21) Appl. No.: 15/267,024

(22) Filed: Sep. 15, 2016

Related U.S. Application Data
(60) Provisional application No. 62/367,626, filed on Jul. 27, 2016.

(51) Int. Cl. G01P 15/135; G01P 15/18; G01P 15/14

(52) U.S. Cl. CPC G01P 15/135; G01P 15/14; G01P 15/18

(57) ABSTRACT

Systems and methods are described herein for determining an inertial parameter. In particular, the systems and methods relate to multiple degrees of freedom inertial sensors implementing time-domain sensing techniques. Within a multiple degrees of freedom inertial sensor system, sense masses may respond to actuation with more than one natural frequency mode, each corresponding to a characteristic motion. Measurement of the inertial parameter can be conducted in the differential natural frequency mode using differential sensing techniques to remove common mode error. The inertial parameter can be acceleration in the vertical dimension. The inertial parameter can be acceleration in the horizontal dimension.

### CROSS REFERENCE TO RELATED APPLICATION

This application claims the benefit of copending, commonly-assigned U.S. Provisional Patent Application No. 62/367,626 filed Jul. 27, 2016, which is hereby incorporated by reference herein in its entirety.

### FIELD OF THE INVENTION

This invention generally relates to systems and methods for detecting and measuring inertial parameters, such as acceleration. In particular, the systems and methods relate to multiple degrees of freedom inertial sensors with reduced common mode error.

### BACKGROUND

Vibratory inertial sensors typically oscillate a sense structure at a known actuation frequency and can monitor perturbations of the sense structure to obtain measurements of inertial parameters or forces. Common mode error, a form of coherent interference resulting from package deformations, temperature gradients, parasitic capacitance, or other electrical noise, may affect the sensitivity of the inertial sensor. This may be particularly pronounced in sensors with multiple sensing signals, where common mode error in both signals becomes combined to produce an even greater error source.

### SUMMARY

Accordingly, systems and methods are described herein for determining an inertial parameter with an inertial device having multiple degrees of freedom. A device comprises a first mass with a first degree of freedom and a second sense mass mechanically coupled to the first sense mass and with a second degree of freedom. A first time domain switch can be coupled to the first sense mass, and a second time domain switch can be coupled to the second sense mass. A drive structure can be configured to oscillate the first sense mass and the second sense mass in a differential frequency mode. The first time domain switch and the second time domain switch can each produce an electrical signal in response to oscillations of the first sense mass and the second sense mass. A processor in signal communication with the first time domain switch and the second time domain switch can be configured to determine an inertial parameter based in part on time intervals produced by the electrical signal.

In some examples, the first sense mass and the second sense mass of the inertial device can oscillate in the differential frequency mode, and the first time domain switch and the second time domain switch can produce a differential signal. In some examples, the inertial device can further comprise coupling springs mechanically coupled to the first sense mass to the second sense mass, and anchoring springs independently mechanically coupled to each of the first sense mass and the second sense mass and a central anchoring structure. The central anchoring structure can be rigidly coupled to a support structure. In some examples, the inertial parameter can be determined using a spring constant of the respective anchoring springs and a spring constant of the coupling springs to reduce the frequency of the differential frequency mode.

In some examples, the common mode frequency component of the electrical signal produced by the first time domain switch and the second time domain switch can be substantially eliminated from the differential signal.

In some examples, the first degree of freedom and the second degree of freedom can be in a vertical dimension. In some examples, the inertial parameter can be acceleration in the vertical dimension.

In some examples, the first time domain switch can further comprise a first electrode at a first radial distance of the first sense mass and a second electrode at a second radial distance of the first sense mass. As the first sense mass and the second sense mass oscillate at the differential frequency mode, the processor can be configured to detect a differential in capacitance of the first electrode and the second electrode. In some examples, the time intervals can be based in part on the times at which the differential in capacitance is equal to zero. In some examples, the first sense mass and the second sense mass raise and lower in the vertical dimension above the support structure. In some examples, the first sense mass and the second sense mass can oscillate in vertical torsional rotation about the central anchoring structure.

In some examples, the first degree of freedom and the second degree of freedom can be in a horizontal dimension. In some examples, the inertial parameter can be acceleration in the horizontal dimension. In some examples, the first sense mass can be mechanically coupled to the second sense mass with a frame, and the frame can oscillate in differential motion with the first sense mass and the second sense mass in-plane with the horizontal dimension.

In some examples, the first time domain switch can comprise a first set of capacitive teeth that can produce a first capacitive current, and the second time domain switch can comprise a second set of capacitive teeth that can produce a second capacitive current. The first capacitive current can be out of phase with the second capacitive current. In some examples, the differential signal can be a linear combination of the first capacitive current and the second capacitive current.

Another example described herein in a method for determining an inertial parameter using multiple degrees of freedom by oscillating a first sense mass in a first degree of freedom, oscillating a second sense mass mechanically coupled to the first sense mass in a second degree of freedom, coupling a first time domain switch to the first sense mass, and a second time domain switch to the second sense mass, producing an electrical signal in response to oscillations of the first sense mass and the second sense mass from each of the first time domain switch and the second time domain switch, and wherein a drive structure oscillates the first sense mass and the second sense mass at a differential frequency mode, and determining an inertial parameter based in part on time intervals produced by the electrical signal.

In some examples, the method can include producing a differential signal from the first sense mass and the second sense mass as the first sense mass and the second sense mass oscillate in the differential frequency mode. In some examples, the method can include mechanically coupling the first sense mass to the second sense mass with coupling springs, and mechanically coupling each of the first sense mass and the second sense mass to a central anchoring structure with anchoring springs. The central anchoring structure can be rigidly coupled to a support structure. In some examples, the method can include determining the inertial parameter using a spring constant of the respective anchoring springs and a spring constant of the coupling springs and reducing the frequency of the differential frequency mode. In some examples, the method can include eliminating a common mode frequency component of the electrical signal produced by the first time domain switch and the second time domain switch from the differential signal.

In some examples, oscillating the first sense mass in the first degree of freedom and oscillating the second sense mass mechanically coupled to the first sense mass in the second degree of freedom can include wherein the first degree of freedom and the second degree of freedom are in a vertical dimension. In some examples, determining the inertial parameter based in part on time intervals produced by the electrical signal can include wherein the inertial parameter is acceleration in the vertical dimension. In some examples, producing the electrical signal in response to oscillations of the first sense mass from the first time domain switch can include generating a capacitance from a first electrode at a first radial distance of the first sense mass, generating a capacitance from a second electrode at a second radial distance of the first sense mass, and as the first sense mass and the second sense mass oscillate at the differential frequency mode, detecting a differential in capacitance of the first electrode and the second electrode.

In some examples, determining the inertial parameter based in part on time intervals produced by the electrical signal can include wherein the time intervals are based in part on a plurality of times at which the differential in capacitance is equal to zero. In some examples, oscillating the first sense mass in the first degree of freedom and oscillating the second sense mass mechanically coupled to the first sense mass in the second degree of freedom can include raising and lowering the first sense mass and the second sense mass in the vertical dimension above the support structure. In some examples, oscillating the first sense mass in the first degree of freedom and oscillating the second sense mass mechanically coupled to the first sense mass in the second degree of freedom can include oscillating in vertical torsional rotation about the central anchoring structure.

In some examples, oscillating the first sense mass in the first degree of freedom and oscillating the second sense mass mechanically coupled to the first sense mass in the second degree of freedom can include wherein the first degree of freedom and the second degree of freedom are in a horizontal dimension. In some examples, the method can include determining the inertial parameter based in part on time intervals produced by the electrical signal can include wherein the inertial parameter is acceleration in the horizontal dimension. In some examples, the method can include producing a first capacitive current from the first time domain switch comprising a first set of capacitive teeth, and producing a second capacitive current from the second time domain switch comprising a second set of capacitive teeth, and wherein the first capacitive current can be out of phase with the second capacitive current. In some examples, determining the inertial parameter based in part on time intervals produced by the electrical signal can include determining a linear combination of the first capacitive current and the second capacitive current.

### BRIEF DESCRIPTION OF THE DRAWINGS

Further features of the subject matter of this disclosure, its nature and various advantages, will be apparent upon consideration of the following detailed description, taken in conjunction with the accompanying drawings, in which like reference characters refer to like parts throughout, and in which:

FIG. 1 depicts a conceptual model of a multiple degrees of freedom inertial sensor, according to an illustrative implementation;

FIG. 2 is a graph showing an example of a frequency response of a multiple degrees of freedom inertial sensor, according to an illustrative implementation;

FIG. 3 depicts a multiple degrees of freedom inertial sensor configured to oscillate in a vertical direction, according to an illustrative implementation;

FIG. 4 depicts the differential mode vertical movement of a multiple degrees of freedom inertial sensor, according to an illustrative implementation;

FIG. 5 depicts the common mode vertical movement of a multiple degrees of freedom inertial sensor, according to an illustrative implementation;

FIG. 6 depicts a multiple degrees of freedom inertial sensor configured for torsional oscillation in a vertical direction, according to an illustrative implementation;

FIG. 7 depicts the differential mode torsional movement of a multiple degrees of freedom inertial sensor, according to an illustrative implementation;

FIG. 8 depicts the common mode torsional rotational movement of a multiple degrees of freedom inertial sensor, according to an illustrative implementation;

FIG. 9 depicts two views of an inertial sensor with recessed moveable beams used for measuring perturbations and oscillations in a vertical direction, according to an illustrative implementation;

FIG. 10 depicts two views of an inertial sensor with recessed fixed beams used for measuring perturbations in a vertical direction, according to an illustrative implementation;

FIG. 11 depicts eight configurations of fixed and moveable beams which may be used in a multiple degrees of freedom inertial sensor to measure perturbations in a vertical direction, according to an illustrative implementation;

FIG. 12 depicts three cross views of the movement of one sense mass of a multiple degrees of freedom inertial sensor and electrodes for measuring perturbations in a vertical direction, according to an illustrative implementation;

FIG. 13 depicts three cross views of the movement of one sense mass of a multiple degrees of freedom inertial sensor and electrodes in a second configuration for measuring perturbation in a vertical direction, according to an illustrative implementation;

FIG. 14 depicts differential mode vertical movement of a multiple degrees of freedom inertial sensor with packaging deformations, according to an illustrative implementation;

FIG. 15 depicts an overhead view of a multiple degrees of freedom inertial sensor for measuring perturbations in a horizontal plane, according to an illustrative implementation;

FIG. 16 depicts three views, each showing a schematic representation of movable and fixed elements of a plurality of time-domain switches used to sense perturbations of a multiple degrees of freedom inertial sensor in a horizontal plane, according to an illustrative implementation;

FIG. 17 depicts a process for extracting inertial information from an inertial sensor, according to an illustrative implementation;

FIG. 18 depicts a conceptual schematic of a one degree of freedom sense mass oscillation, according to an illustrative implementation;

FIG. 19 is a graph showing the in phase and out of phase capacitive response to a sense mass oscillation produced by TDS structures of a multiple degrees of freedom inertial sensor, according to an illustrative implementation;

FIG. 20 depicts in phase and out of phase capacitive sense structures for sensing perturbations in a horizontal plane, according to an illustrative implementation;

FIG. 21 is a graph representing the relationship between analog signals derived from a multiple degrees of freedom inertial sensor and the displacement of a sense mass of a multiple degrees of freedom inertial sensor, according to an illustrative implementation;

FIG. 22 is a graph illustrating a current response to the displacement of a sense mass of a multiple degrees of freedom inertial sensor, according to an illustrative implementation;

FIG. 23 is a graph showing a rectangular-wave signal produced from zero-crossing times of the current signal depicted in FIG. 24, according to an illustrative implementation;

FIG. 24 is a graph showing time intervals produced from non-zero crossing reference levels, according to an illustrative implementation;

FIG. 25 is a graph showing the effects of an external perturbation on the output signal of the multiple degrees of freedom inertial sensor, according to an illustrative implementation;

FIG. 26 is a graph depicting capacitance as a function of the displacement of a sense mass of a multiple degrees of freedom inertial sensor, according to an illustrative implementation;

FIG. 27 is a graph depicting the first spatial derivative of capacitance as a function of the displacement of a sense mass of a multiple degrees of freedom inertial sensor, according to an illustrative implementation;

FIG. 28 is a graph depicting the second spatial derivative of capacitance as a function of the displacement of a sense mass of a multiple degrees of freedom inertial sensor, according to an illustrative implementation;

FIG. 29 is a graph depicting the time derivative of the capacitive current as a function of displacement of a sense mass of a multiple degrees of freedom inertial sensor, according to an illustrative implementation;

FIG. 30 is a graph depicting the displacement offsets of two sense masses as a result of common mode error, according to an illustrative implementation;

FIG. 31 is a graph depicting the results of differential sensing on the sensed displacement of a multiple degrees of freedom inertial sensor, according to an illustrative implementation;

FIG. 32 is a graph representing position of a sense mass relative to time, according to an illustrative implementation;

FIG. 33 is a graph representing velocity of a sense mass relative to time, according to an illustrative implementation;

FIG. 34 is a graph representing acceleration of a sense mass relative to time, according to an illustrative implementation;

FIG. 35 is a graph representing capacitance relative to angular position, according to an illustrative implementation;

FIG. 36 is a graph representing capacitive slope relative to angular position of a sense mass, according to an illustrative implementation;

FIG. 37 is a graph representing capacitive curvature relative to angular position of a sense mass, according to an illustrative implementation;

FIG. 38 is a graph representing capacitance relative to time and produced in response to oscillations of a sense mass, according to an illustrative implementation;

FIG. 39 is a graph representing capacitive slope relative to time and produced in response to oscillations of a sense mass, according to an illustrative implementation;

FIG. 40 is a graph representing capacitive curvature relative to time and produced in response to oscillations of a sense mass, according to an illustrative implementation;

FIG. 41 is a graph representing differential capacitance relative to time and produced in response to oscillations of a sense mass, according to an illustrative implementation;

FIG. 42 is a graph representing capacitive slope relative to time and produced in response to oscillations of a sense mass, according to an illustrative implementation;

FIG. 43 is a graph representing capacitive curvature relative to time and produced in response to oscillations of a sense mass, according to an illustrative implementation;

FIG. 44 is a graph representing capacitance relative to the vertical position of a sense mass, according to an illustrative implementation;

FIG. 45 is a graph representing capacitive slope relative to the vertical position of a sense mass, according to an illustrative implementation;

FIG. 46 is a graph representing capacitive curvature relative to the vertical position of a sense mass, according to an illustrative implementation;

FIG. 47 is a graph representing capacitance relative to time and produced in response to oscillations of a sense mass, according to an illustrative implementation;

FIG. 48 is a graph representing capacitive slope relative to time and produced in response to oscillations of a sense mass, according to an illustrative implementation;

FIG. 49 is a graph representing capacitive curvature relative to time and produced in response to oscillations of a sense mass, according to an illustrative implementation;

FIG. 50 depicts a flow chart of a method for extracting inertial parameters from a nonlinear periodic signal, according to an illustrative implementation;

FIG. 51 depicts a flow chart of a method for determining transition times between two values based on a nonlinear periodic signal, according to an illustrative implementation; and

FIG. 52 depicts a flow chart of a method for computing inertial parameters from time intervals, according to an illustrative implementation.

### DETAILED DESCRIPTION

To provide an overall understanding of the disclosure, certain illustrative implementations will now be described, including systems and methods for reducing common mode error when detecting and measuring inertial parameters using a vibratory accelerometer.

Vibratory accelerometers use the measured perturbations of an oscillating sense mass to determine inertial parameters and forces acting on a sensor. These perturbations may be physical perturbations of the sense mass from a neutral equilibrium, and may be converted to analog electrical signals as a result of the electro-mechanical nature of a sensing system. Any accelerometer may be sensitive to temperature changes, long-term mechanical creep, environmental vibrations, packaging deformations, parasitic capacitance, drift in bias voltages, drift in any internal voltage references, and other environmental or electrical noise sources. In accelerometers, these error sources will affect the accuracy of the sensor, thus reducing its ability to measure inertial parameters and inertial forces such as an input acceleration.

One form of error that affects accelerometers is common mode error. Common mode error is a form of interference, for example, coherent interference, where an error exists equally and in phase on multiple signal paths, and is therefore not easily distinguished or isolated from the desired signal information, since combining signal paths together will simply compound or amplify the error. Examples include temperature changes, long-term mechanical creep, environmental vibrations, packaging deformations, parasitic capacitance, drift in bias voltages, drift in any internal voltage references, ground loops, and other environmental or electrical error or noise sources that result in systematic errors.

One way to reduce the affects of these error sources is to employ sensing techniques that produce multiple signals as a result of a single motion in such a way that their linear combination will in fact remove or detect the systematic error present in both signals. One of these techniques is “differential sensing,” where computing the difference between two signals results in the elimination of common mode error present in both signals, leaving a scalar multiple of the “true” signal without common mode error. For example, two signals may be generated so that a first signal is phase offset from the second signal by 180°. These “anti-phase” signals may then be subtracted from each other to remove common mode error. In another example, two signals may be generated that are inverses of each other using positive or negative-biased electrodes, and then may be subtracted from each other to remove common mode error. Any other sensing technique that produces a difference or “differential” between two signals may be used to implement differential sensing.

Common mode error may also occur in a specific frequency range of a sense mass oscillation in a vibratory accelerometer. While differential sensing techniques may be employed, a downside of a vibratory accelerometer with a single sense mass is that there is only a single motion from which to generate electrical signals in response to perturbations, and there is only a single resonant frequency response of the sense mass. Thus the frequency range at which inertial parameters are measured may in fact also be the frequency range in which common mode error primarily resides. In this case, differential sensing techniques may not be able to fully remove the common mode error signal from the measured output signal.

In multiple degrees of freedom inertial sensor, however, more than one sense mass may be coupled together, producing multiple detectable motions in response to a single external perturbation or acceleration. The motion of each sense mass is a degree of freedom of the inertial sensor system. In the context of a vibratory accelerometer in which the sense masses are driven into oscillation, each degree of freedom will correspond to an additional normal mode frequency response of the system. For example, in a two degree of freedom sense structure system with two sense masses that are both actuated at a drive frequency, the system will respond at a range of frequencies that are a function of the drive frequency, the mass of each sense mass, the coupling between the masses, and other structural factors. However, the system will have two “natural frequency modes” which correspond to the eigenvalue solutions of the equations of motion of the system. These natural frequency modes, which are the frequencies at which the system would oscillate in the absence of driving forces, will be resonant frequencies of the two degree of freedom system. Oscillations at these frequencies will amplify the motion of both sense masses, resulting in amplitude peaks in the frequency response of the system. For an N-degree of freedom oscillating system, there will be N corresponding natural modes for each of the N eigenvalue solutions to the system's equations of motion (where N is any positive integer).

These natural modes will correspond to both a characteristic frequency and a characteristic physical motion of the sense masses. Again, in the example of a typical two-degree of freedom system, one natural mode, a “low” natural mode, will generally correspond to in-phase, common mode motion of the two sense masses, wherein both masses move together with the same amplitude in the same direction. In a typical system, this “low” natural mode will be at a lower energy or frequency than a second “high” natural mode. This second “high” natural mode will generally correspond to anti-phase, differential motion of the two sense masses, when both masses will move with the same amplitude in opposite directions, 180° out of phase with each other. A typical N-degree of freedom system will have this same minimum “low” natural mode, where all N masses move in-phase with each other, and a maximum “high” natural mode, where the maximum number of alternating pairs of the N masses move anti-phase with each other. For example, in a typical four degree of freedom system, the “high” natural mode will correspond to motion in which masses 1 and 2 move out of phase with each other, masses 2 and 3 move out of phase with each other, and masses 3 and 4 move out of phase with each other.

However, while the natural frequency modes will always correspond to characteristic physical motions of the sense masses, it is possible to introduce structural forces to the system to alter the typical correspondence described above. For example, one may create a system where the differential, anti-phase motion of sense masses actually corresponds to the lower energy, lower frequency natural mode response of the multiple degrees of freedom system. In this case, the common mode, or in phase motion of the sense masses would in fact be at the higher energy, higher frequency natural mode response.

The natural frequency modes of a multiple degrees of freedom vibratory accelerometer are useful because they allow for the isolation of common mode error to the in-phase response of the accelerometer, and detection of inertial parameters primarily at a second, anti-phase frequency response in which common mode error can be eliminated via differential movement of the sense masses. Isolating sensing to the differential mode thus allows for the elimination of common mode errors when measuring inertial parameters. The multiple natural mode frequency responses of the system also allow for more flexibility in engineering the system, since it allows one to tune the in-phase frequency response to a frequency range of common mode error, and tune the out-of-phase, measurement frequency response to the desired sensing range, which may in fact be at the first, lower frequency mode response of the system.

Thus sensing of acceleration may be done primarily at the differential frequency mode, in which the sense masses of the multiple degrees of freedom accelerometer move anti-phase to each other in the lower natural frequency mode response. In this mode, the common mode error affecting each sense mass will be eliminated from the signal by subtracting or combining the signals from each sense mass. Since the signals will be 180° out of phase with each other, any common mode error present in both signals will be eliminated from the resulting combined output signal, leaving only the desired signal reflecting the sense mass' displacement.

In vibratory accelerometers, because the physical movement of the sense mass translates to its output analog signal, the physical frequency of oscillation of the sense mass has a direct relation to the sensitivity of the inertial sensor. For accelerometers, the ratio of the linear displacement of a sense mass to the input acceleration, which describes the ability of a signal (denoted S_{accel}) produced by the sense mass to detect acceleration has the general relation:

$${S}_{accel} ∝ \frac{1}{{f}_{s}^{2}} \qquad ( 1 )$$

where f_{S} is the frequency of oscillation of the sense mass. As can be appreciated, in order to increase the sensitivity of the accelerometer, one would ideally minimize the value of f_{S}. Thus by introducing structural forces into the system that make the differential, anti-phase motion of the sense masses correspond to the lower frequency mode response, one may accomplish differential sensing, eliminate common mode noise, and still preserve the sensitivity of the accelerometer.

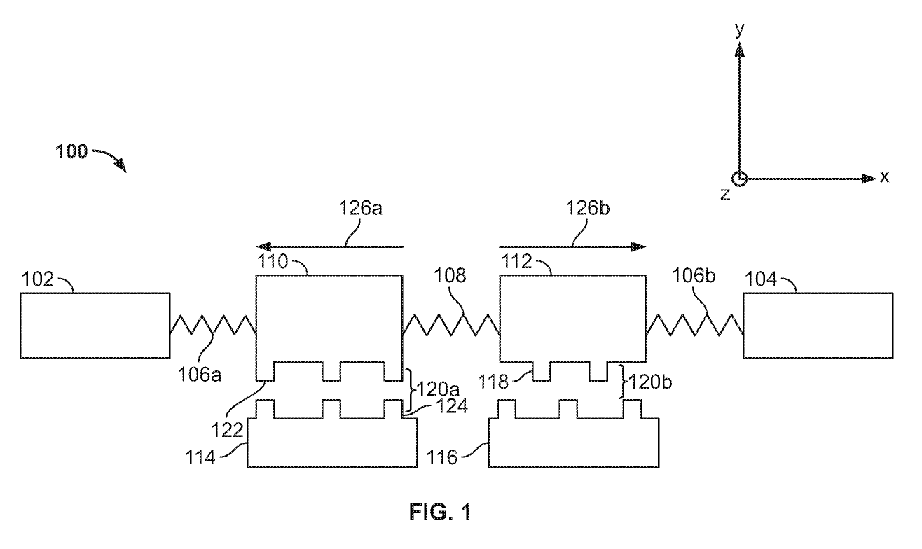

FIG. 1 depicts a conceptual model of a multiple degrees of freedom inertial sensor, according to an illustrative implementation. FIG. 1 will demonstrate the geometric choices available to reject or eliminate the common mode response of the inertial sensor from the differential mode response which is used to measure inertial parameters.

Differential sensing may first be achieved by mechanically driving the two sense masses 110 and 112 in their natural differential frequency mode, meaning in opposite directions at the same amplitude, as indicated by the arrows 126a and 126b respectively. Springs 106a, 106b, and 108 may be configured such that this differential frequency mode is the first, lower frequency mode response of the system. Springs 106a, 106b, and 108 may be configured such that the common mode motion, in which sense masses move in-phase in the same direction, is the second, higher frequency mode response of the system. The sense masses 110 and 112 may be suspended in the z axis from anchors 102 and 104 by anchoring springs 106a and 106b above a bottom layer (not shown) of the multiple degrees of freedom inertial sensor. A coupling spring 108 may mechanically couple the two sense masses 110 and 112 together. Springs 106a, 106b and 108 may be substantially compliant in only the x axis, as shown in FIG. 1. Sense structures, shown in FIG. 1 as time-domain switch (“TDS”) structures 120a and 120b can convert the oscillations of sense masses 110 and 112 into analog electrical signals derived from the displacement of the sense masses 110 and 112. The TDS structures 120a and 120b are each composed of one set of teeth 122 and 118 coupled to the sense masses 110 and 112 respectively, and a second set of teeth 114 and 116 rigidly coupled to the bottom layer of the multiple degrees of freedom inertial sensor. Each mass may be driven anti-phase to each other with independent drive structures (not shown).

The drive structures described herein may be capacitive comb drives. The capacitive comb drives may have one stationary set of teeth rigidly coupled to the bottom layer of a multiple degrees of freedom inertial sensor, while a second, interdigitated set is connected to the sense mass, such as sense mass 110 or 112. The drive structures may also be any device capable of driving the sense masses into oscillation. The electrical signal controlling the drive structures may be a constant electrical signal generated through feedback circuitry to maintain the differential frequency mode of the sense masses 110 and 112. The feedback circuitry may also adjust a drive voltage to the drive structures until the amplitude of the sense masses 110 and 112 oscillation reaches a desired setpoint. This setpoint may be an amplitude associated with a resonant frequency or natural mode frequency of the multiple degrees of freedom inertial sensor. This setpoint may be an amplitude associated with a differential frequency mode response of the multiple degrees of freedom inertial sensor, which occurs at the first, lower frequency mode response of the system. Another example of a control signal may be a periodic “pinged” signal that is turned on and off, creating a stepped electrostatic force to initiate harmonic oscillation. The “pinged” signal may be coordinated between drive structures on opposite sides of the sense masses 110 and 112 in the x-axis, to create a “push/pull” electrostatic force. The drive structures may be powered on or off in response to a user initiating or closing an application on a mobile device. Start up times of oscillating inertial devices can range from 10 milliseconds to multiple seconds, depending on the quality factor of the sense masses and other design factors.

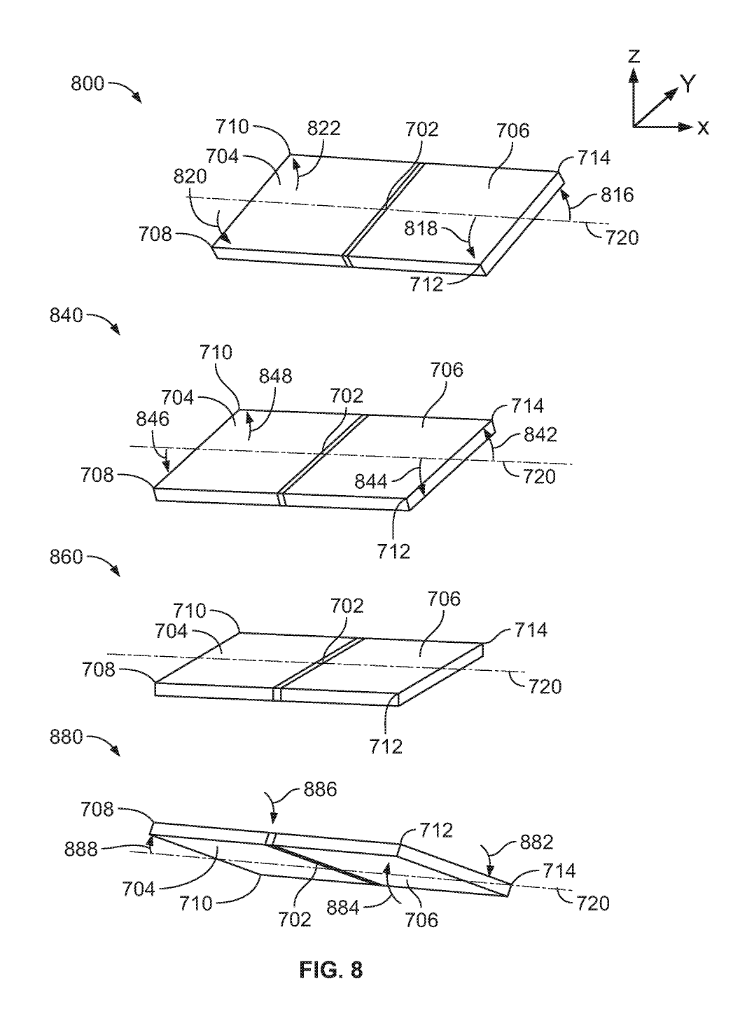

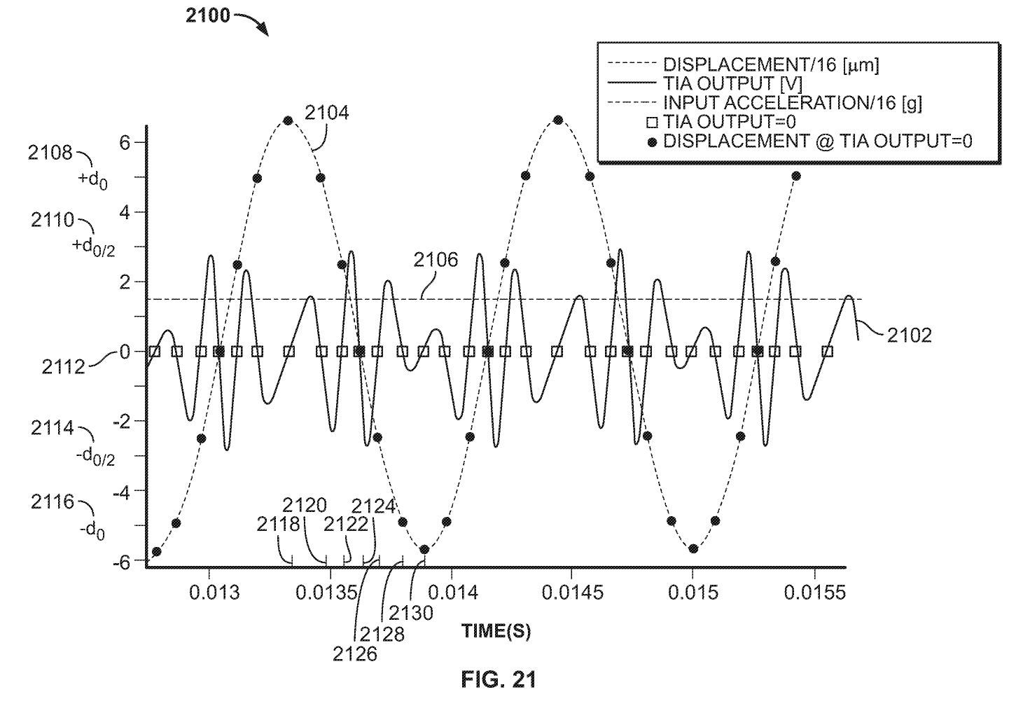

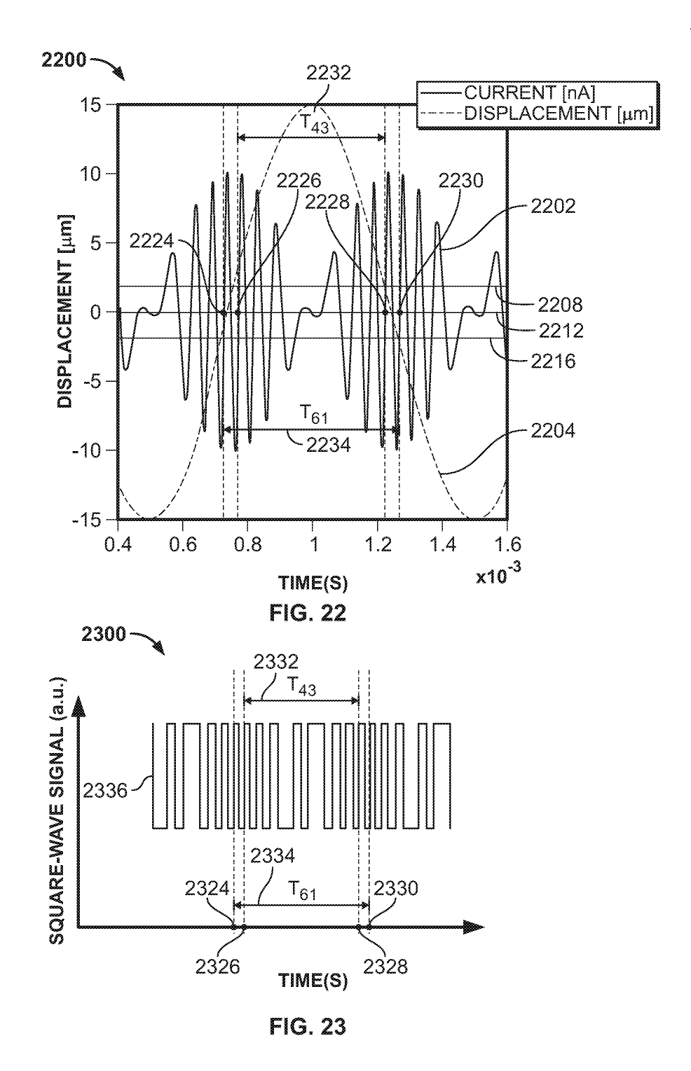

In combination with the differential motion of the sense masses 110 and 112, the differential sensing of acceleration may also be achieved with in and out of phase TDS structures, as shown at 120a and 120b. The in-phase TDS structure has teeth 122 and 114 that are in alignment in their neutral position, meaning that when the sense mass 110 has a net zero force acting on it, the teeth 122 are at a minimum distance in the y-direction from the teeth 114, as shown in FIG. 1. The out of phase TDS structure has teeth 118 and 116 that are anti-aligned in their neutral position, meaning that when the sense mass 112 has a net zero force acting on it, the teeth 118 are at a maximum distance in the y-direction from teeth 116. As sense masses 110 and 112 oscillate differentially at 180° out of phase with each other in the directions indicated by arrows 126a and 126b, the aligned, or in-phase TDS structure 120a and the out of phase TDS structure 120b will each produce signals that are themselves differential and 180° out of phase with each other. The teeth 122, 114, and 118 and 116 may be configured to produce signals any phase shift angle from each other as desired. The resulting analog signals will thus be produced by both differential motion as shown at 126a and 126b, and differential detection. The analog signals from teeth 120a and 120b may be linearly combined with each other as desired, and will reject common mode error both from the sense masses 110 and 112's physical motion, and from the electrical sensing of their displacement. The signals produced by in and out of phase TDS structures are discussed in more detail with reference to FIGS. 21-22. These structures as shown in FIG. 1 may also be replaced by any of the sensing structures described herein, and for example, in reference to FIGS. 8-12, 15 and 21-22.

Anchoring springs 106a and 106b, as well as coupling spring 108 and any of the springs described herein each have an inherent value called a spring constant. A spring constant is an intrinsic property of a spring, which describes its relative compliance to outside forces. Thus springs with low spring constants expand or comply more to outside forces than springs with high spring constants. The spring constants of springs 106a, 106b and 108 and any of the springs described herein may each be defined purely by the geometry and material of the springs. The stiffness of the springs 106a, 106b and 108 and any of the springs described herein can be affected by temperature. Thus, changes in ambient or sensor temperature can result in changes in spring stiffness, resulting in changes in resonant frequency of the structure 100. Springs 106a, 106b and 108 may be comprised of a uniform isotropic material, such as doped or undoped silicon. Springs may also have varying widths, segments, segment lengths, and moments of inertia to tailor portions of the springs and achieve the desired spring constants. Springs 106a, 106b and 108 may be configured to lower the frequency associated with differential motion of the sense masses, such that in a two degree of freedom system the first natural frequency mode response corresponds to differential motion, while the second natural frequency mode response corresponds to common mode, in-phase motion.

The natural frequencies of the two degree of freedom system as shown in FIG. 1 will be dependent on the masses of the two sense masses 110 and 112, denoted M₁ and M₂, the spring constants of the anchoring springs 106a and 106b, denoted k₁ and k₂, and the spring constant of the coupling spring, denoted k_{C}. In a typical example where M₁=M₂ and k₁=k₂, the two natural frequencies of the system shown in FIG. 1 might be:

$$\begin{matrix}{ω}_{D} = \sqrt{\frac{{k}_{1} + 2 {k}_{C}}{{M}_{1}}} & ( 2 ) \\ {ω}_{C} = \sqrt{\frac{{k}_{1}}{{M}_{1}}} & ( 3 )\end{matrix}$$

where ω_{D} is typically the higher differential mode which would normally correspond to anti phase motion of the sense masses 110 and 112, and ω_{C} is typically the lower common mode corresponding to in phase motion of the sense masses 110 and 112. These are the classic frequency solutions to the two-degree of freedom system shown in FIG. 1, and are given here as examples of the dependency of the frequencies on each of the variables in the system shown in FIG. 1. However, it is possible to introduce structural forces into the system shown in FIG. 1 such that the differential motion of the sense masses corresponds to the lower energy, lower frequency natural mode response. The system shown in FIG. 1 may also have different mass values for sense mass 110 and 112, and different values for the spring constants of 106a and 106b. The system shown in FIG. 1 may have more than two sense masses. In all of these cases, the natural frequencies of the system will still depend on the spring constants of the coupling or anchoring springs, and the masses of the sense masses. For any N degree of freedom system, the N natural modes will also depend on the masses of the N sense masses and the spring constants of all of the coupling and anchoring springs. These variables are all values that can be fixed and determined through fabrication of the multiple degrees of freedom inertial sensor, meaning that the natural modes will also be fixed.

As shown in Equations (2) and (3), the values of the common mode and differential mode frequencies of oscillation may be determined by selecting the stiffness of the coupling and anchoring springs, as well as the masses of the sense masses 110 and 112. The differential frequency mode may be between 500 and 20,000 Hz, and is preferably 5,000 Hz.

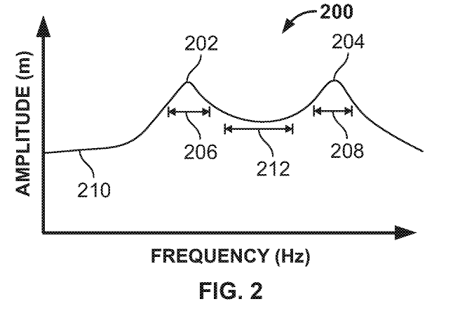

FIG. 2 is a graph showing an example of a frequency response of a multiple degrees of freedom inertial sensor, according to an illustrative implementation. The x axis shows the drive frequency, while the y axis shows the displacement amplitude of the sense masses. In the low frequency region 210, the sense mass response is approximately linear. As shown in FIG. 2, the low frequency differential mode response produces a peak in amplitude at 202, while the higher frequency common mode response produces a second peak in the amplitude response at 204. In a two-degree of freedom system, these two amplitude peaks correspond to the two natural mode frequencies of the system. Detection and sensing of acceleration occurs at the lower frequency, differential mode response at 202. The distance between these two normal mode responses, shown at 212, may be adjusted by changing the spring constants or mass values of the multiple degrees of freedom inertial sensor. The spring constants and mass values will also define the amplitudes and frequencies of peaks 202 and 204. To isolate the differential frequency response at 202 from the common mode response at 204, the distance 212 may be increased. The width of the peaks, shown at 206 and 208, may be defined by the Q factor of the multiple degrees of freedom inertial sensor.

FIG. 2 is an example of the frequency response of a two degree of freedom inertial sensor with two sense masses, however there may be any number of sense masses, where additional degrees of freedom will result in the same number of additional peaks in the amplitude response. Thus an N degree of freedom inertial sensor will have N number of corresponding peaks across the full frequency spectrum in the sense masses amplitude response. For an N degree of freedom inertial sensor, there will be a lowest common mode frequency, and a higher differential mode frequency response.

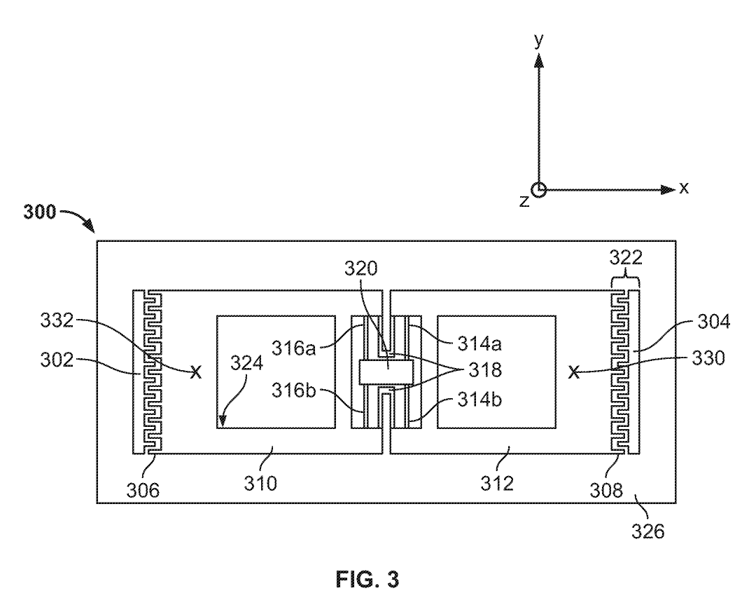

FIG. 3 depicts a multiple degrees of freedom inertial sensor configured to oscillate in a vertical direction, according to an illustrative implementation. FIG. 3 is an implementation of the conceptual diagram shown in FIG. 1 for z axis oscillation and sensing of z axis acceleration for a two degree of freedom system. FIG. 3 includes a central anchor 320 rigidly coupled to a bottom layer 326 of the multiple degrees of freedom inertial sensor, a first sense mass 310 coupled to the anchor 320 with a first pair of anchoring springs 316a and 316b, and a second sense mass 312 coupled to the central anchor 320 via a second pair of anchoring springs 314a and 314b. The sense mass 310 is mechanically coupled to the sense mass 312 via coupling springs 318. The sense masses 310 and 312 may be suspended in the z axis above the bottom layer 326. Sense structures 302 and 304 rigidly coupled to the bottom layer 326 may detect the sense masses 310 and 312 motion in the z axis and convert it to an analog electrical signal.

The multiple degrees of freedom inertial sensor 300 comprises three layers: a device layer containing the features depicted at 302, 304, 306, 308, 310, 312, 314a, 314b, 316a, 316b, 318, 320, and 322, a bottom layer 326, and a cap layer (not shown). The bottom layer 326 and the cap layer may be made from different wafers than the device layer. One or more of the features of the device layer may be made from the wafers containing the bottom layer 326 and/or the cap layer. The space between the bottom layer 326 and the cap layer may be at a constant pressure below atmospheric pressure. The space between the bottom layer 326 and the cap layer may be at partial vacuum. A getter material such as titanium or aluminum may be deposited on the interior of the space to maintain reduced pressure over time.

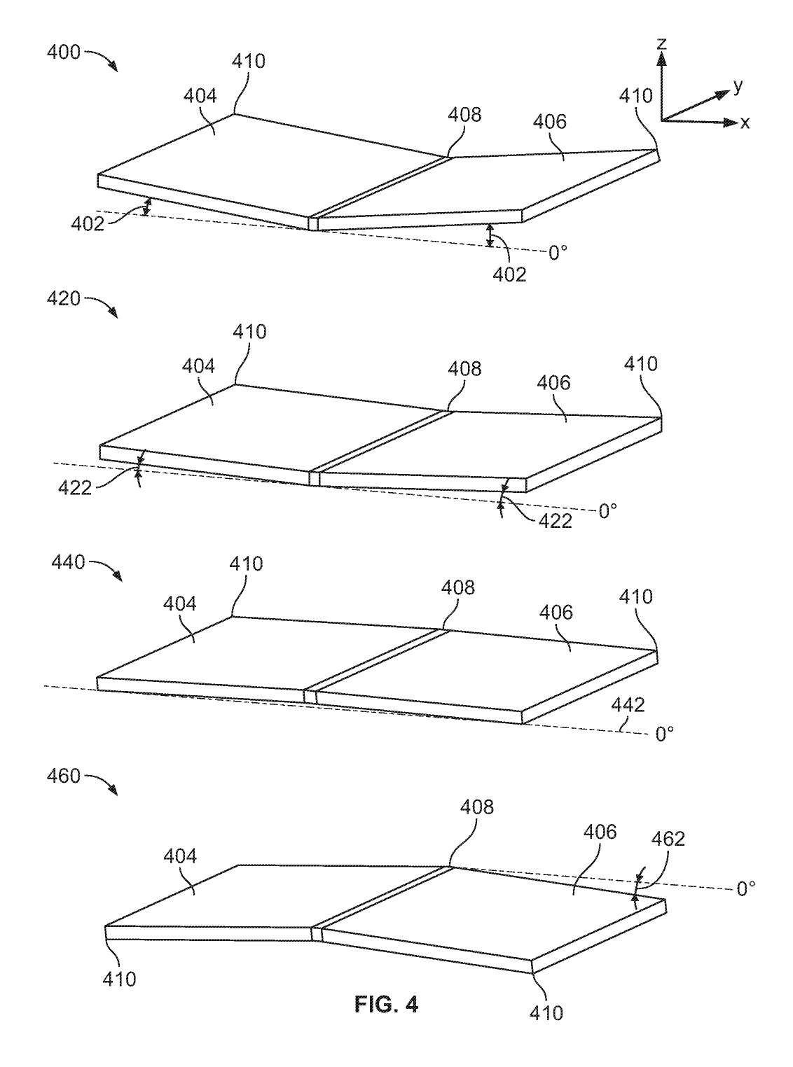

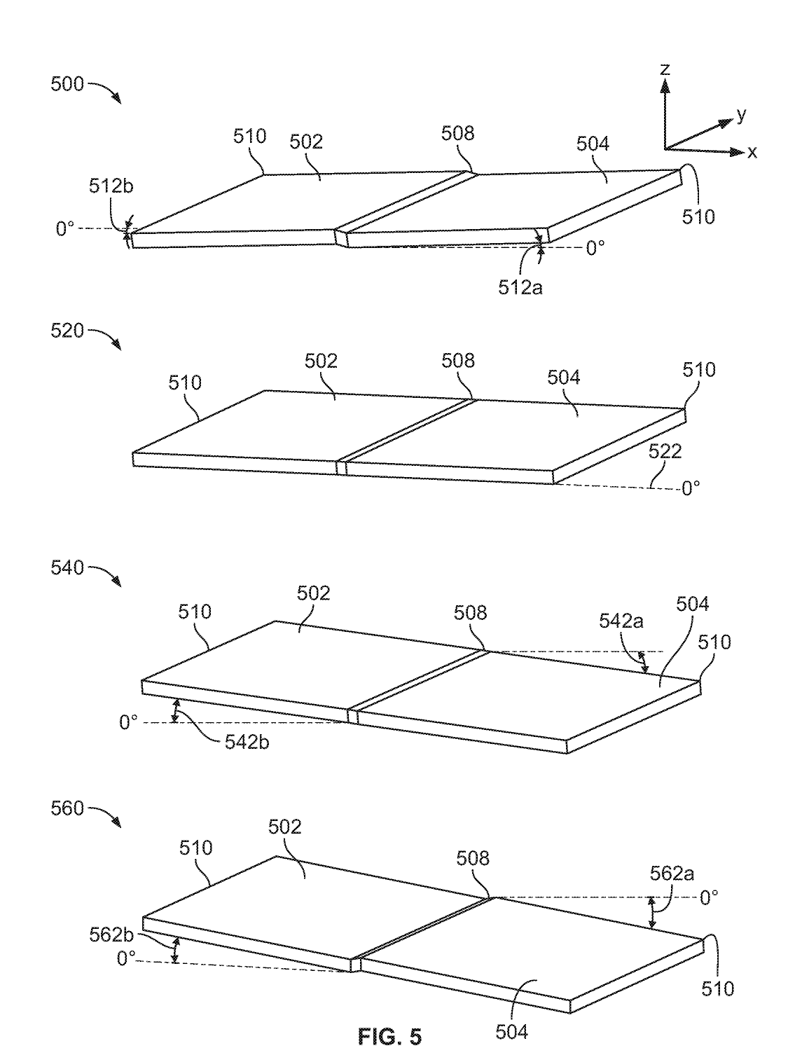

The anchoring springs 314a, 314b, 316a and 316b are shown in FIG. 3 as rectangular structures hinging sense masses 310 and 312 to the central anchor 320. These springs may also contain “u” bends, may be serpentine or in any configuration that allows the sense masses 310 and 312 to rotationally oscillate in the z direction about the central anchor 320. This motion is described in further detail with reference to FIG. 4-5. The coupling springs 318 are shown with “u” bends, but may be serpentine or in any configuration that restricts the motion of the sense masses 310 and 312 in they or x direction so that they oscillate in the z-axis. The springs 314a, 314b, 316a, 316b and 318 may also be configured to promote the differential motion of sense masses 310 and 312 over their common mode motion, where an example of the differential motion is shown in FIG. 4, and is the first, lower frequency mode, and an example of the common mode motion is shown in FIG. 5, and is the second, higher frequency mode.

The motion of the sense masses 310 and 312 (as described in FIG. 4 and FIG. 5) may have both a rotational, torsional component and an out-of-plane bending component of motion in the z axis. The anchoring springs 314a, 314b, 316a and 316b may have different stiffness responses to the torsional movement as opposed to the bending movement. The springs 314a, 314b, 316a and 316b may have a lower effective spring constant in response to torsional motion, and a higher effective spring constant in response to bending motion. The common mode motion may have a larger bending component of motion than torsional component of motion, whereas the differential motion may have a larger torsional component of motion than bending component of motion. As a result of the variable stiffness of the springs in response to these two components of motion, the differential motion may be associated with a lower energy, lower frequency response of the system, while the common mode, in-phase motion may be associated with a higher energy, higher frequency response of the system. Other structural forces may also increase the stiffness response of the system to the common mode motion, effectively increasing the energy and frequency response associated with common mode motion, while lowering the frequency response associated with differential motion.

The sense masses 310 and 312 are shown in FIG. 3 as rectangles with removed interiors. Sense masses 310 and 312 may also be in any topography that allows for symmetric, differential motion, as described in FIG. 4. The location of the removed mass (shown as the removed interior of sense masses 310 and 312) may be chosen such that the center of mass of the sense masses 310 and 312 are located away from the anchor 320. Thus, more mass is left towards the ends of the sense masses 310 and 312 that are shown in FIG. 3 interfacing with the sense structures 302 and 304 respectively, placing the center of mass 332 and 330 away from the anchor 320. In addition to removing mass from the sense masses 310 and 312 to place the center of mass 332 and 330, it is possible to adjust the thickness of the sense masses in the z-dimension. The locations 332 and 330 promote differential motion of the sense masses 310 and 312, as well as the out-of-plane motion in the z direction. The center of mass of the sense masses 310 and 312 may thus be centered in their y dimension, as shown at 332 and 330 and also offset in their x dimension, as shown at 310 and 312 to encourage the desired oscillation motion. The center of mass may also be placed anywhere that may produce differential motion of the two sense masses 310 and 312.

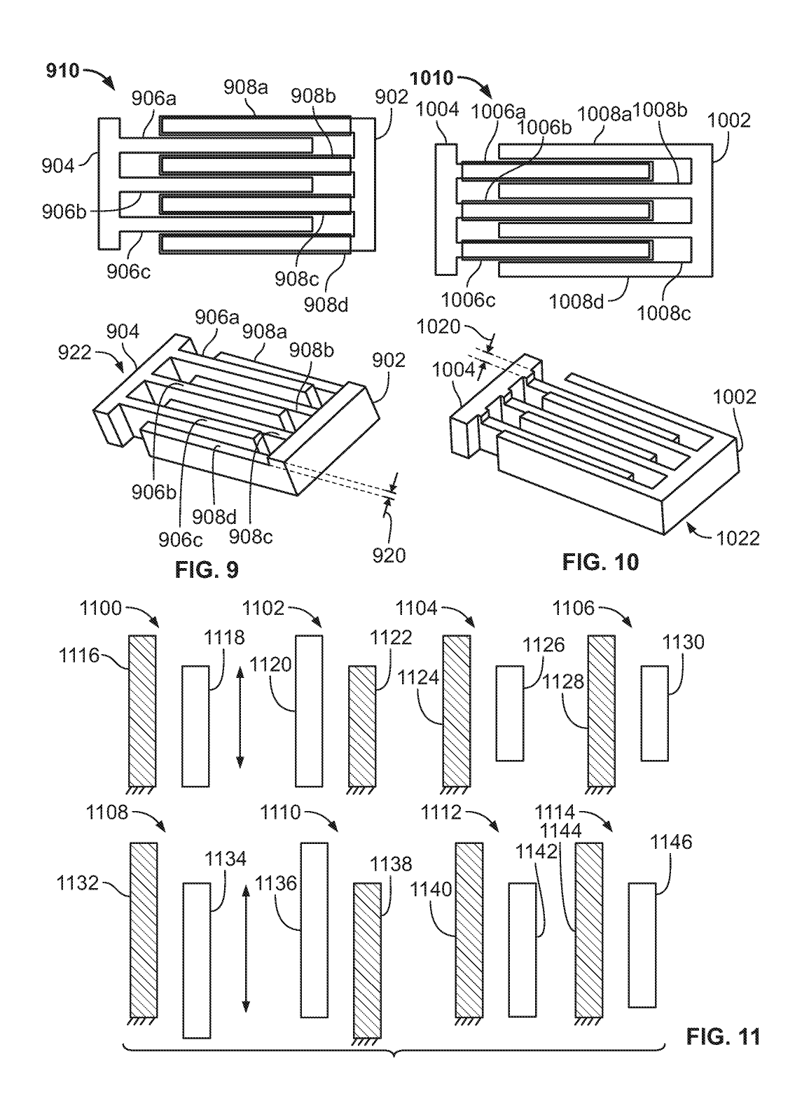

Sense structures are shown with a first set of teeth at 306 and 308 coupled to the sense masses 310 and 312 respectively. A second set of teeth 304 and 302 are shown as interdigitated, for example at 322, with teeth 306 and 308, and rigidly coupled to the bottom layer 326 of the multiple degrees of freedom inertial sensor. The teeth of these sense structures may be configured such that the analog signals produced by one set will be out of phase with the other, thus differentially sensing the oscillations of sense masses 310 and 312. These sense structures may be any of the TDS structures described herein, for example those described in further detail with reference to FIGS. 9-13, 16 and 19-20. These structures may also be any capacitive, optical or general means for producing an electrical signal in response to the sense masses 310 and 312 displacement and oscillation. The sense structures may also be parallel plate capacitors formed between electrodes deposited in the bottom layer 326 below each of the sense masses 310 and 312, and the bottoms of the sense masses 310 and 312 themselves, such that movement of the sense masses 310 and 312 in the z dimension are translated to changes in capacitance between the sense masses 310 and 312 and the bottom layer 326. Differential driving of the sense masses and differential sensing of their oscillation will substantially eliminate common mode error from the electrical signals produced by the TDS structures.

FIG. 4 depicts the differential mode vertical movement of a multiple degrees of freedom inertial sensor, according to an illustrative implementation. The movement shown in FIG. 4 is that of the first, lower natural frequency mode of the two-degree of freedom system. A central anchor shown at 408 may connect the sense masses 404 and 406 to an anchoring structure (not shown). The central anchor as shown at 408 may be comprised of the anchoring springs 314a, 314b, 316a and 316b and coupling springs 318 as shown in FIG. 3. At 400, the sense masses 404 and 406 have free ends 410 that are at a positive altitude angle as indicated at 402. At any given moment in their oscillation, the altitude angle of sense mass 404 may be the same as that of sense mass 406. The free ends 410 of sense masses 404 and 406 may be coupled to TDS structures or any other sense structure to convert their displacement to an analog electrical signal. 400 depicts the maximum positive displacement of the sense masses 404 and 406.

At 420, the free ends 410 of both sense masses 404 and 406 have moved in the negative z-direction from their positions indicated in 400, rotating about the central anchor 408 and reducing the altitude angle as shown at 422. At 440, the free ends 410 of both sense masses 404 and 406 have moved further in the negative z direction, and are in the horizontal plane as indicated at 442. In this position 440, sense masses 404 and 406 will be parallel to a bottom layer of the multiple degrees of freedom inertial sensor (not shown). This may be the neutral position of the sense masses 404 and 406, meaning that in the absence of drive forces they would be at this position 440.

At 460, the free ends 410 of both sense masses 404 and 406 have moved still further in the negative z direction, and now form a negative altitude angle as indicated at 462. 460 represents a minimum displacement of the free ends 410, meaning that the free ends 410 at their lowest point in the z-axis.

The sequence of positions 400, 420, 440 and 460 represent one half cycle of the sense masses 404 and 406 vertical oscillation. To complete the full cycle, the sense masses 404 and 406 will move in the positive z direction from minimum position 460, going from position 460, to 440, to 420, and reaching their maximum displacement again at 400. The positions shown in FIG. 4 are intended as representative models, and may be exaggerated for clarity.

FIG. 5 depicts the common mode vertical movement of a multiple degrees of freedom inertial sensor, according to an illustrative implementation. The movement shown in FIG. 5 is that of the second, higher natural frequency mode of the two-degree of freedom system. This motion is the disfavored motion of sense masses shown in FIG. 3, and may contain common mode error in the resulting output signal produced by this motion. A central anchor shown at 508 may connect the sense masses 502 and 504 to an anchoring structure (not shown). The central anchor as shown at 508 may be comprised of the anchoring springs 314a, 314b, 316a and 316b and coupling springs 318 as shown in FIG. 3. These springs may be configured to disfavor the oscillation response of sense masses 502 and 504 as shown in FIG. 5. At 500, the sense mass 504 is at a positive altitude angle as shown at 512a, while sense mass 502 is at a negative altitude angle as shown at 512b. These angles may be equal and opposite of each other. At any give moment in their oscillation, the magnitude of the altitude angle of sense mass 502 is the same as that of sense mass 504. The free ends 510 of sense masses 502 and 504 may be coupled to TDS structures or any other sense structure to convert their displacement to an analog electrical signal.

At 520, the free ends 510 of the sense masses 502 and 504 have moved in the positive and negative z directions respectively, and are in the horizontal plane as indicated at 522. In this position 520, sense masses 502 and 504 will be parallel to a bottom layer of the multiple degrees of freedom sense (not shown). This may be the neutral position of the sense masses 502 and 504, meaning that in the absence of drive forces they would be at this position 520.

At 540, the free end 510 of sense mass 502 has moved in the positive z direction, while the free end 510 of sense mass 504 has moved in the negative z direction. Thus sense mass 502 now makes a positive altitude angle as indicated at 542b, while sense mass 504 makes a negative altitude angle as indicated at 542a. Finally, at 560, after further movement of the free end 510 of sense mass 502 in the positive z direction, and further movement of the free end of 510 of sense mass 504 in the negative z direction, the sense mass 504 forms a negative altitude angle as shown at 562b, while sense mass 502 forms a positive altitude angle as shown at 562a.

Thus in the common mode motion as shown in FIG. 5, both sense masses 502 and 504 move as a single mass as they rotate about the central anchor 508. There is no differential produced by the motion of the two sense masses 502 and 504. This is not the preferred motion of the sense masses 502 and 504, and common mode error may be isolated to the frequency response associated with this common mode motion.

The sequence of positions 500, 520, 540 and 560 represent one half cycle of the sense masses 504 and 506 vertical oscillation. To complete the full cycle, the sense masses 504 and 506 will move in the z direction, going from position 560, to 540, to 520, and back to 500. The positions shown in FIG. 5 are intended as representative models, and may be exaggerated for clarity.

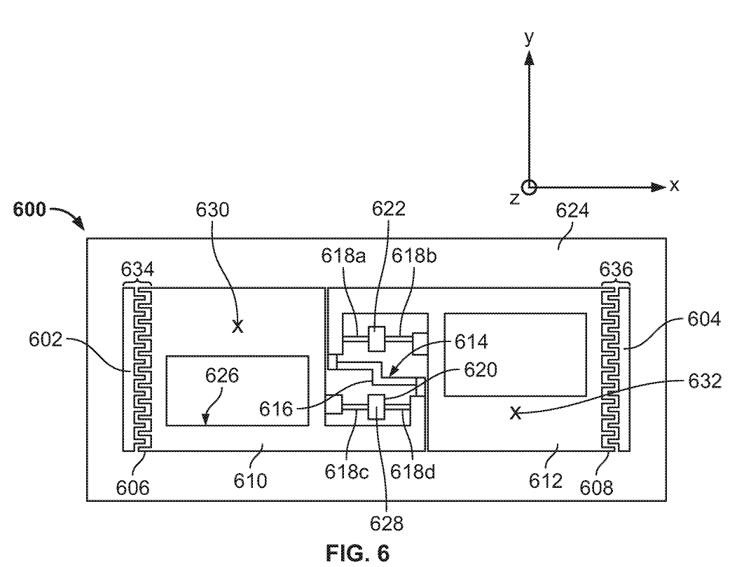

FIG. 6 depicts a multiple degrees of freedom inertial sensor configured for torsional oscillation in a vertical direction, according to an illustrative implementation. FIG. 6 is another implementation of the conceptual diagram shown in FIG. 1 for z axis oscillation and sensing of z axis acceleration for a two degree of freedom system. FIG. 6 includes two central anchors 622 and 628 mechanically coupled to sense masses 612 and 610 respectively and rigidly coupled to a bottom layer 624 of the multiple degrees of freedom inertial sensor 600. Anchoring springs 618a and 618b mechanically connect the sense mass 612 to the central anchor 622, while a second set of anchoring springs 618c and 618d mechanically connect the sense mass 610 to the central anchor 628. A coupling spring 614 mechanically couples sense mass 610 to sense mass 612. Sense structures 602 and 604 may detect the sense masses 610 and 612 torsional motion in the z axis and convert it to an analog electrical signal. Mechanically coupled may mean a physical connection, such as a spring, between elements of the multiple degrees of freedom inertial sensor such that forces are conveyed between them.

The multiple degrees of freedom inertial sensor 600 comprises three layers: a device layer containing the features depicted at 602, 604, 606, 608, 610, 612, 614, 616, 618a, 618b, 618c, 618d, 620, 622, a bottom layer 624, and a cap layer (not shown). The bottom layer 624 and the cap layer may be made from different wafers than the device layer. One or more of the features of the device layer may be made from wafers containing the bottom layer 624 and/or the cap layer. The space between the bottom layer 624 and the cap layer may be at a constant pressure below atmospheric pressure. The space between the bottom layer 624 and the cap layer may be at partial vacuum. A getter material such as titanium or aluminum may be deposited on the interior of the space to maintain reduced pressure over time.

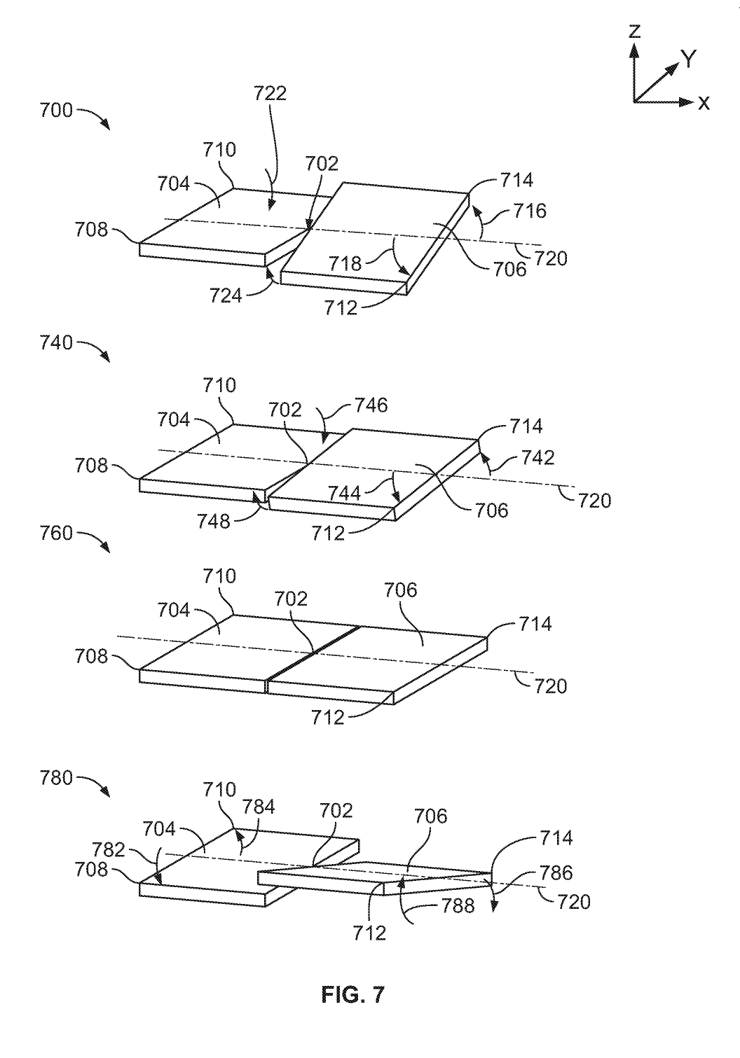

The anchoring springs 618a, 618b, 618c and 618d are shown in FIG. 6 as rectangular structures hinging sense masses 610 and 612 to the central anchors 628 and 622, respectively. These springs may also contain “u” bends, may be serpentine or in any configuration that allows the sense mass 610 to torsionally oscillate in the z direction about an x axis whose origin is centered at 616. This motion is described in further detail with reference to FIG. 7-8. The coupling spring is shown with a bend at 616, but may have “u” bends, be serpentine, or in any configuration that restricts the motion of the sense masses 610 and 612 to promote the differential motion of the sense masses 610 and 612 over their common mode motion. An example of the differential motion of sense masses 610 and 612 is shown in FIG. 7, and is the first, lower natural frequency mode of the system, while an example of the common mode motion is shown in FIG. 8, and is the second, higher natural frequency mode of the system.

The motion of the sense masses 610 and 612 (as described in FIG. 7 and FIG. 8) may have both a rotational, torsional component and an out-of-plane bending component of motion in the z axis. The anchoring springs 618a, 618b, 618c and 618d (collectively 618) may have different stiffness responses to the torsional movement as opposed to the bending movement. The springs 618 may have a lower effective spring constant in response to torsional motion, and a higher effective spring constant in response to bending motion. The common mode motion may have a larger bending component of motion than torsional component of motion, whereas the differential motion may have a larger torsional component of motion than bending component of motion. As a result of the variable stiffnesses of the springs in response to these two components of motion, the differential motion may be associated with a lower energy, lower frequency response of the system, while the common mode motion may be associated with a higher energy, higher frequency response of the system. The distance between springs 618a and 618b from springs 618c and 618d may also increase the stiffness response to the bending component of motion, pushing the common mode, out-of phase motion into the higher natural frequency mode response. Other structural forces may also increase the stiffness response of the system to the common mode motion, effectively increasing the energy and frequency response associated with common mode motion, while lowering the frequency response associated with differential motion.

The sense masses 610 and 612 are shown in FIG. 6 as rectangles with removed interiors. Sense masses 610 and 612 may also be in any topography that allows for symmetric, differential motion at the first, lower natural frequency mode. The center of mass of the sense mass 610 may be located at 630 and 632. The location of the removed mass (shown as the removed interior of sense masses 610 and 612) may be chosen such that the center of mass of the sense masses 610 and 612 are located away from their respective anchors 628 and 622. Thus, more mass is left towards the negative y direction of sense mass 612, whereas more mass is left towards the positive y direction of sense mass 610. In addition to removing mass from the sense masses 610 and 612 to place the center of mass 632 and 630, it is possible to adjust the thickness of the sense masses in the z-dimension. The locations 632 and 630 promote differential motion of the sense masses 610 and 612, as well as the out-of-plane torsional rotational motion shown in FIG. 7.

Sense structures 634 and 636 are shown with a first set of teeth at 606 and 608 coupled to the sense masses 610 and 612 respectively. A second set of teeth 602 and 604 are shown as interdigitated with the first set of teeth 606 and 608, and rigidly coupled to the bottom layer 624 of the multiple degrees of freedom inertial sensor. The teeth of these sense structures may be configured such that the analog electrical signals produced by one set will be out of phase with the other, thus differentially sensing the oscillations of sense masses 610 and 612. These sense structures may be TDS structures, as describe in further detail with reference to FIGS. 9-10 and 16. The sense structures may also be parallel plate capacitors formed between electrodes deposited in the bottom layer 624 below each of the sense masses 610 and 612, and the bottoms of the sense masses 610 and 612 themselves, such that movement of the sense masses 610 and 612 in the z dimension are translated to changes in capacitance between the sense masses 610 and 612 and the bottom layer 624. These structures may also be any capacitive, optical or general means for producing an electrical signal in response to the sense masses 510 and 512 displacement.

FIG. 7 depicts the differential mode torsional movement of a multiple degrees of freedom inertial sensor, according to an illustrative implementation. The movement shown in FIG. 7 is that of the first, lower natural frequency mode of the two-degree of freedom system. A central anchor shown at 702 may couple the sense masses 704 and 706 to an anchoring structure (not shown). The central anchor as shown at 702 may be comprised of anchoring springs 618a, 618b, 618c and 618d, as well as coupling spring 614 as shown in FIG. 6. Both sense masses 704 and 706 will oscillate in vertical torsional rotation about a central anchor 702 and axis 720.

At 700, the free end 714 of sense mass 706 forms a positive altitude angle as indicated at 716. The other free end 712 of sense mass 706 makes an equal and opposite altitude angle as indicated at 718. Thus the sense mass 706 is symmetrically “twisted” or rotated about its central x axis in the vertical or z direction. The sense mass 704 is symmetrically “twisted” about the central axis 720 to mirror the motion of sense mass 706. Thus the corresponding free end 710 of sense mass 704 to the free end 714 of sense mass 706 makes an equal and opposite altitude angle as indicated at 722. This angle 722 is the same as angle 718. The other free end 708 makes a positive altitude angle as indicated at 724. This angle 724 is the same as angle 716. Thus, throughout the vertical rotational torsional oscillation of sense masses 704 and 706, the free end 710 may form the same altitude angle as the free end 712, while the free end 708 will form the same altitude angle as the free end 714. 700 represents the maximum displacement of free ends 714 and 708, and the minimum displacement of free ends 710 and 712.

At 740, free ends 710 and 712 have moved in the positive z direction, forming altitude angles 746 and 744 respectively. Free ends 708 and 714 have moved in the negative z direction, forming altitude angles 748 and 742 respectively. Thus the angles 742, 744, 746 and 748 are all smaller in magnitude than the angles 716, 718, 722 and 724. The sense masses 706 and 704 rotate about the central axis 720, forming these indicated angles with the horizontal.

At 760, the free ends 710, 708, 714 and 712 are all level with the horizontal and with each other. The surface of sense masses 706 and 704 are therefore flat and level with each other. 760 represents the midpoint in the oscillation of sense masses 706 and 704. This may also be the resting position of sense masses 704 and 706, such that in the absence of torsional forces or drive forces, the sense masses 704 and 706 would remain in this position. The surface of sense masses 704 and 706 may be, at 760, parallel to a bottom layer of the multiple degree of freedom inertial sensor (not shown).

At 780, the sense masses 706 and 704 have rotated about the central axis 720. The free end 710 of sense mass 704 has moved in the positive z direction, while the free end 708 of 704 has moved in the negative z direction. The free end 714 of sense mass 706 has moved in the negative z direction, while free end 712 of sense mass 706 has moved in the positive z direction. Thus the free ends 712 and 710 both make positive altitude angles 784 and 788 with the horizontal, respectively, while free ends 708 and 714 both make negative altitude angles 782 and 786 with the horizontal, respectively. The magnitudes of angles 782, 784, 786 and 788 may all be the same. 780 represents the maximum displacement for free ends 710 and 712, and a minimum displacement for free ends 708 and 714.

The sequence of positions 700, 740, 760 and 780 represent one half cycle of the sense masses 704 and 706 vertical torsional rotational oscillation. To complete the full cycle, the sense masses 704 and 706 will rotate about the axis 720, going from position 780, to 760, to 740, and back to 700. The positions shown in FIG. 7 are intended as representative models, and may be exaggerated for clarity.

FIG. 8 depicts the common mode torsional rotational movement of a multiple degrees of freedom inertial sensor, according to an illustrative implementation. The motion shown in FIG. 8 is that of the higher natural frequency mode of the two-degree-of-freedom system. This motion is the disfavored motion of sense masses 610 and 612 shown in FIG. 6, and may contain common mode error in the analog electrical output signal produced by its motion. The sense masses 704 and 706 oscillate in tandem about the central axis of rotation 720 in their common mode.

At 800, the free end 710 of sense mass 704 and the free end 714 of sense mass 706 form positive altitude angles with the horizontal, shown at 816 and 822 respectively. The free end 708 of sense mass 704 and the free and 712 of sense mass 706 form negative altitude angles with the horizontal, shown at 818 and 820. At any given time in the sense masses 704 and 706 oscillation about the central axis 720 in the common mode motion shown in FIG. 8, the free end 710 may form the same altitude angle as the free end 714, while the free end 708 may form the same altitude angle as the free end 712. The magnitude of altitude angles 822, 816, 818 and 820 may be the same.

At 840, the free ends 710 and 714 have moved in the negative z direction, while the free ends 708 and 712 have moved in the positive z direction. The free ends 710 and 714 form positive altitude angles 842 and 848 respectively. The free ends 708 and 712 form negative altitude angles 844 and 846 respectively. The magnitude of altitude angles 842, 844, 846 and 848 may be the same.

At 860, the free ends 710 and 714 have moved further in the negative z direction, while free ends 708 and 712 have moved further in the positive z direction. The free ends 708, 710, 712, and 714 are level with the horizontal, and therefore do not form any altitude angles with the horizontal. 860 may be the resting position of the sense masses 704 and 706, meaning that in the absence of drive forces or outside perturbations they would return to this position. At 860, the sense masses 704 and 706 may be parallel to a bottom layer of the multiple degrees of freedom inertial sensor (not shown).

At 880, the free ends 708 and 712 have moved in the positive z direction, while the free ends 710 and 714 have moved in the negative z direction. Free ends 708 and 712 therefore form positive altitude angles with the horizontal, shown at 888 and 884, respectively. The magnitude of altitude angles 882, 884, 886 and 888 may be the same. At 880, the free ends 710 and 714 may be at their minimum displacement, while free ends 708 may be at their maximum displacement. 880 may be the halfway point in the period of oscillation of sense masses 702 and 706. To complete a full cycle, the free ends may move from position 880 to 860, to 840 and return to 800.

FIG. 9 depicts two views of an inertial sensor with recessed moveable beams used for measuring perturbations and oscillations in a vertical direction, according to an illustrative implementation. FIG. 9 depicts a fixed element 904 and a moveable element 902. The fixed element 904 includes beams 906a, 906b, and 906c (collectively, beams 906). The moveable element 902 includes beams 908a, 908b, 908c, and 908d (collectively, beams 908). The fixed beams 906 are the same height as the fixed beam 904, and the moveable beams 908 are shorter than the fixed beams 906 and the moveable element 902 by a distance 920. The beams shown in FIG. 9 form a TDS structure capable of measuring time intervals.

FIG. 10 depicts two views of an inertial sensor with recessed fixed beams used for measuring perturbations in a vertical direction, according to an illustrative implementation. FIG. 10 depicts a moveable element 1002 and a fixed element 1004. The moveable element 1002 has moveable beams 1008a, 1008b, 1008c, and 1008d (collectively, beams 1008). The fixed beam 1004 includes fixed beams 1006a, 1006b, and 1006c (collectively, beams 1006). The fixed beams 1006 are recessed by a distance 1020 such that the top surface of the fixed beams 1006 is lower than the top surface of the fixed element 1004 and the top surface of the moveable beams 1008. The structures depicted in FIGS. 9 and 10 can be used to implement any of the structures depicted in FIG. 11. The beams shown in FIG. 10 form a TDS structure capable of measuring time intervals.

FIG. 11 depicts eight configurations of fixed and moveable beams which may be used in a multiple degrees of freedom inertial sensor to measure perturbations in a vertical direction, according to an illustrative implementation. FIG. 11 includes views 1100, 1102, 1104, 1106, 1108, 1110, 1112, and 1114. The view 1100 includes a fixed beam 1116 and a moveable beam 1118 that is shorter than the fixed beam 1116. At rest, the lower surface of the moveable beam 1118 is aligned with the lower surface of the fixed beam 1116. As the moveable beam is displaced upward by one-half the difference in height between the two beams, the capacitors between the two beams is at a maximum. When the capacitance is at a maximum, the capacitive current is zero and can be detected using a zero-crossing detector as described herein.

The view 1102 includes a moveable beam 1120 and a fixed beam 1122. The moveable beam 1120 is taller than the fixed beam 1122, and the lower surfaces of the moveable fixed beams are aligned in the rest position. As the moveable beam is displaced downward by a distance equal to one-half the distance in height of the two beams, capacitance between the two beams is at a maximum.

The view 1104 includes a fixed beam 1124 and a moveable beam 1126 that is shorter than the fixed beam 1124. The center of the moveable beam is aligned with the center of the fixed beam such that in the rest position, the capacitance is at a maximum.

The view 1106 includes a fixed beam 1130 and a moveable beam 1128 that is taller than the fixed beam 1130. At rest, the center of the moveable beam 1128 is aligned with the center of the fixed beam 1130 and capacitance between the two beams is at a maximum.

The view 1108 includes a fixed beam 1132 and a moveable beam 1134 that is the same height as the fixed beam 1132. At rest, the lower surface of the fixed beam 1132 is above the lower surface of the moveable 1134 by an offset distance. As the moveable beam 1134 moves upward by a distance equal to the offset distance, capacitance between the two beams is at a maximum because the overlap area is at a maximum.

The view 1110 includes a fixed beam 1138 and a moveable beam 1136 that is the same height as fixed beam 1138. In the rest position, the lower surface of the moveable beam 1136 is above the lower surface of the fixed beam 1138 by an offset distance. As the moveable beam travels downward by a distance equal to the offset distance, the overlap between the two beams is at a maximum and thus capacitance between the two beams is at a maximum.

The view 1112 includes a fixed beam 1140 and a moveable beam 1142 that is shorter than the fixed beam 1140. In the rest position, the lower surfaces of the two beams are aligned. As the moveable beam 1142 moves upwards by a distance equal to one-half the difference in height between the two beams, overlap between the two beams is at a maximum and thus capacitance is at a maximum.

The view 1114 includes a fixed beam 1146 and a moveable beam 1144 that is taller than the fixed beam 1146. In the rest position, the lower surface of the moveable beam 1144 is below the lower surface of the fixed beam by an arbitrary offset distance. As the moveable beam 1144 moves downwards such that the center of the moveable beam 1144 is aligned with the center of the fixed beam 1146, the overlap area reaches a maximum and thus capacitance between the two beams reaches a maximum. For each of the configurations depicted in FIG. 11, a monotonic motion of the moveable beam produces a non-monotonic change in capacitance resulting in an extremum in capacitance. For all of the configurations depicted in FIG. 11, when capacitance between the two beams is at a maximum, the capacitive current is zero. The beams shown in FIG. 11 may be used to measure time intervals between zero-crossings. These zero-crossings may be used to determine inertial parameters.

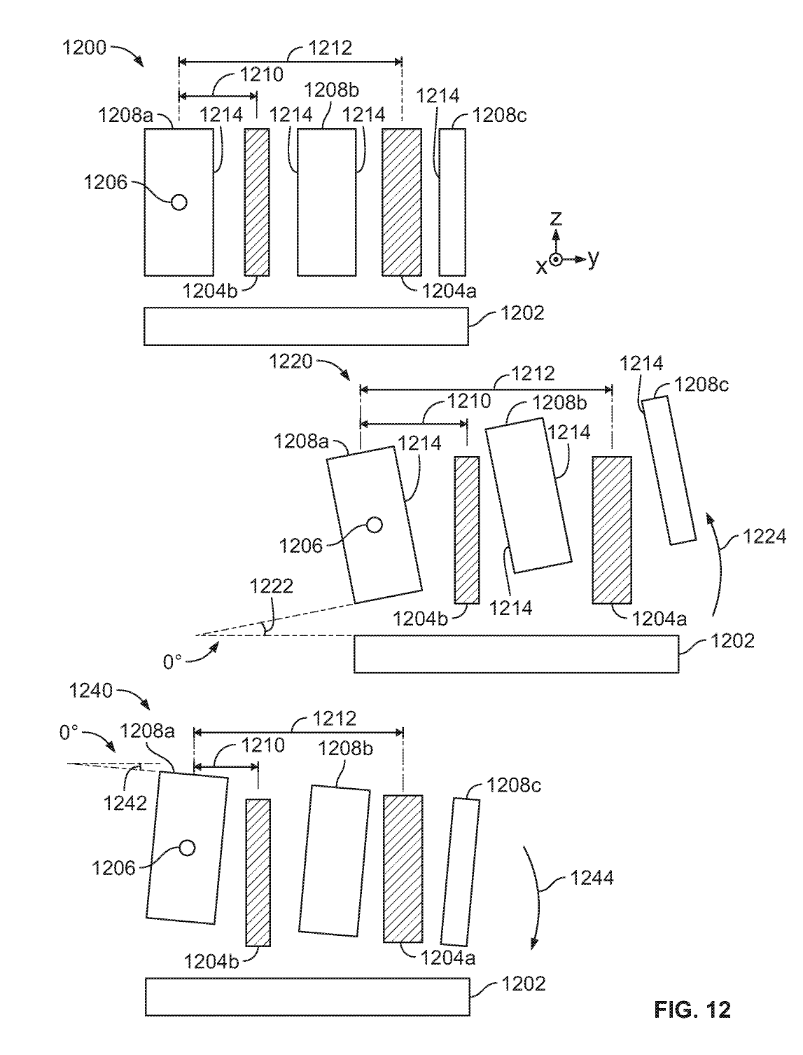

FIG. 12 depicts three cross views of the movement of one sense mass of a multiple degrees of freedom inertial sensor and electrodes for measuring perturbations in a vertical direction, according to an illustrative implementation. FIG. 12 shows the bottom layer 1202 of the multiple degrees of freedom inertial sensor, a sense mass comprised of connected segments 1208a, 1208b and 1208c (collectively 1208), and sense electrodes 1204a and 1204b. The sense mass 1208 has a pivot point 1206, around which it rotates in a vertical direction as shown at 1220 and 1240. At 1200, the sense mass 1208 may be at equilibrium, meaning that in the absence of drive forces or external perturbations, it would remain at this position. At 1200, the sense mass may be parallel to the bottom layer 1202.

The central anchor depicted at 1206 may include coupling springs and drive springs to mechanically connect the sense mass 1208 to a second sense mass (not shown) of a multiple degrees of freedom inertial sensor. The central anchor depicted at 1206 may be rigidly coupled to the bottom layer 1202. The sense mass may be driven by drive structures (not shown) positioned below the sense mass 1208 on the bottom layer 1202, or in any other configuration capable of producing the oscillation shown at 1200, 1220 and 1240. The electrodes 1204a and 1204b are spaced at a radius 1212 and 1210, respectively, from a rotational pivot point 1206 of the proof mass. Radius 1210 is smaller than radius 1204a. Additionally, as shown, the electrode 1204b has a smaller area than the electrode 1204a, and thus 1204b has a smaller nominal capacitance than 1212. The electrodes 1204a and 1204b may be rigidly coupled to the bottom layer 1202. They are shown as separated by the segment of the sense mass 1208b.

The inner walls of the sense mass, shown at 1214, interface with the sense electrodes 1204a and 1204b, and may contain electrodes or capacitive plates, meaning that the sense electrodes and sense masses may form parallel plate capacitors between each other, producing capacitive current as the result of their relative movement and change in capacitance. Additionally, as shown, the first electrode 1204b has a smaller area than the second electrode 1204a, and thus the first electrode has a smaller nominal capacitance than the second electrode.

At 1220, the sense mass 1208 has reached its maximum vertical displacement, forming a positive altitude angle 1222 as a result of the movement of its free end as indicated by arrow 1224. At 1240, the sense mass 1208 has reached its minimum vertical displacement, forming a negative altitude angle 1242 as a result of the movement of its free end as indicated by arrow 1244. Angle 1222 may have the same magnitude as angle 1242.

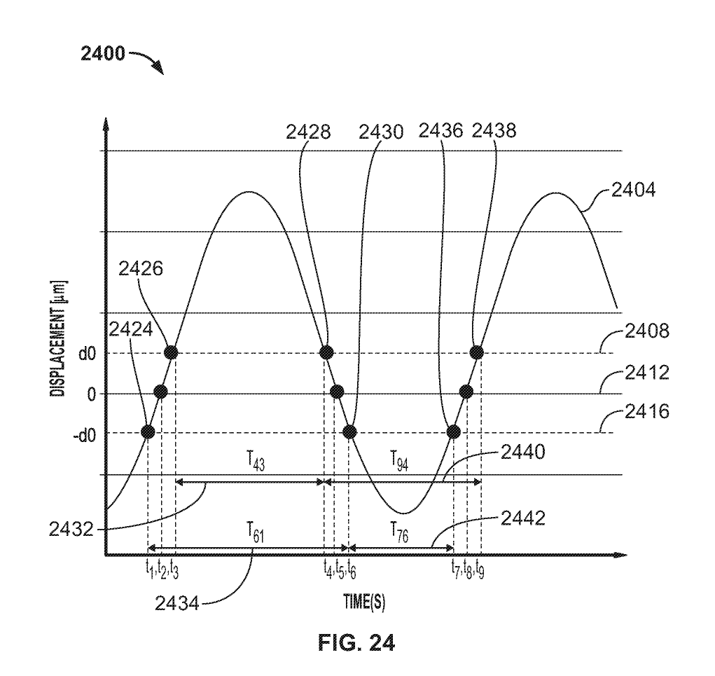

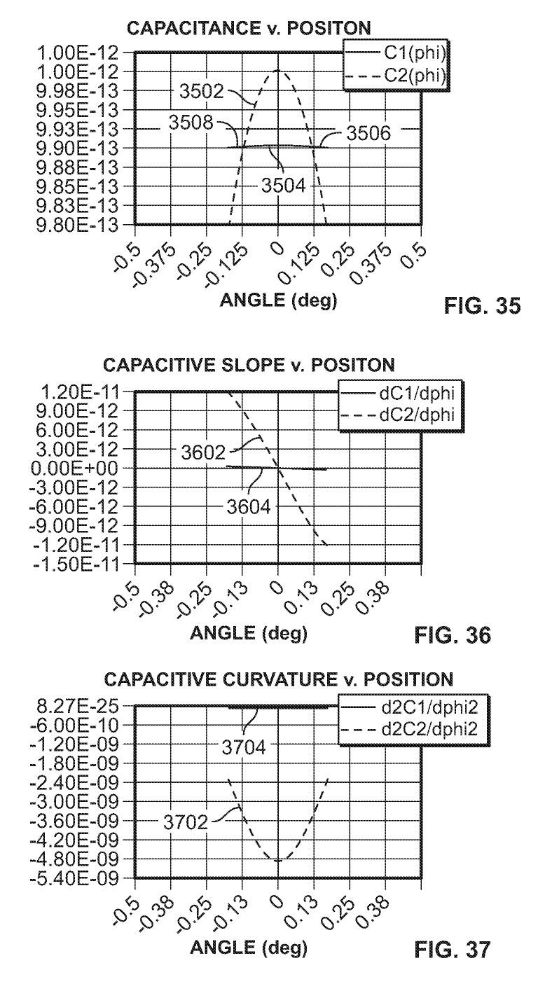

As the proof mass rotates in the directions indicated at 1224 and 1244, both the capacitance of the first electrode 1204b and second electrode 1204a will decrease from the maximum capacitance shown at position 1200. Since the second electrode 1204a is positioned at a larger radius 1212, the electrode has an offset relative to the tilting proof mass that increases faster than that of the first electrode 1204b. This also means that the second electrode 1204a's capacitance decreases faster than that of the first electrode 1204b. As such, during a rotation of the proof mass 1208, the second electrode 1204a's capacitance decreases from a magnitude greater than to a magnitude less than that of the first electrode 1204b's capacitance. Thus, at some particular altitude angle ±φ, the capacitance of the first electrode 1204b and the second electrode 1204a will be equal, giving a differential capacitance of zero at angle ±φ. This capacitance relation between the first electrode 1204b and the second electrode 1204a is shown in further detail with reference to FIGS. 35-43. An algorithm, such as the Cosine algorithm, or any of the algorithms as described with reference to FIG. 24, is able to use these points of zero differential capacitance to determine acceleration and other inertial parameters.

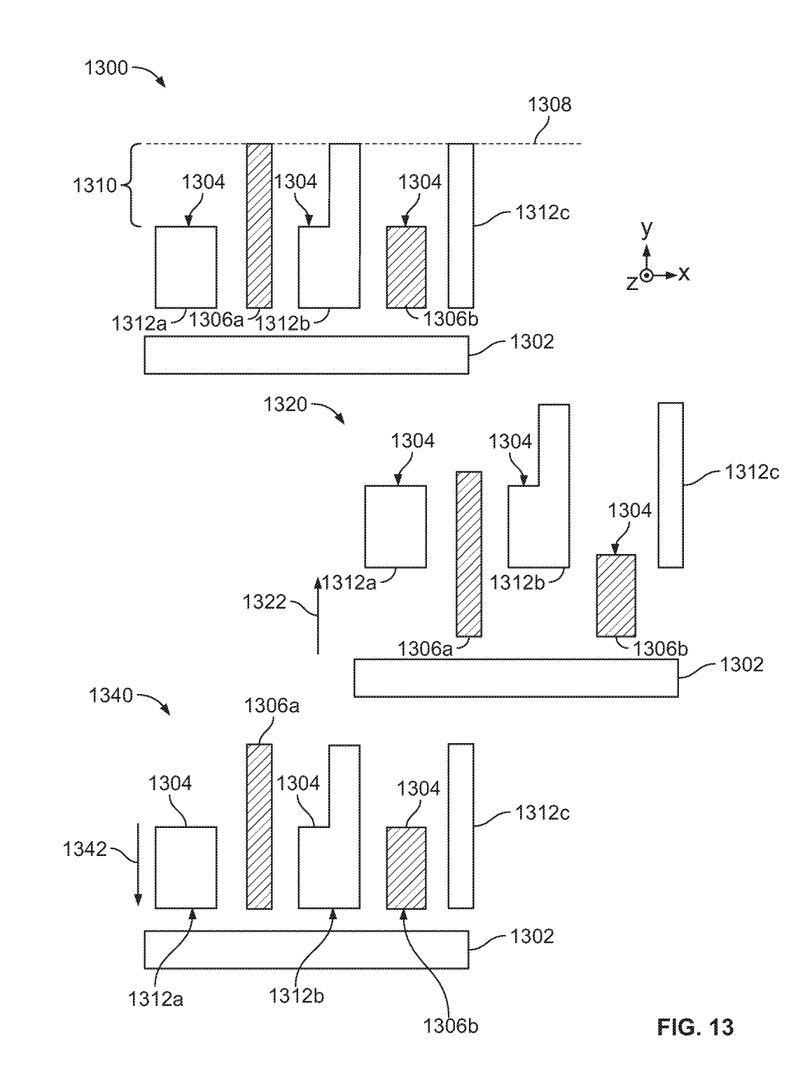

FIG. 13 depicts three cross views of the movement of one sense mass of a multiple degrees of freedom inertial sensor and electrodes in a second configuration for measuring perturbation in a vertical direction, according to an illustrative implementation. FIG. 13 shows the bottom layer 1302 of the multiple degrees of freedom inertial sensor, a sense mass comprised of connected segments 1312a, 1312b and 1312c (collectively, 1312), and sense electrodes 1306a and 1306b. The sense mass 1312 may have a pivot point (not shown) located at the left-most end of sense mass segment 1312a as shown in FIG. 13, which allows it to oscillate in the vertical direction as shown at 1320 and 1340. At 1300, the sense mass 1312 may be at equilibrium, meaning that in the absence of drive forces or external perturbations, it would remain at this position. At 1300, 1320 and 1340, the sense mass may be parallel to the bottom layer 1302.

The pivot point may include coupling springs and drive springs to mechanically connect the sense mass 1312 to a second mass (not shown) of a multiple degrees of freedom inertial sensor. The pivot point may be rigidly coupled to the bottom layer 1302. The sense mass 1312 may be driven by drive structures (not shown) positioned below the sense mass 1312 on the bottom layer 1302, or in any other configuration capable of producing the oscillation shown at 1320 and 1340. Electrode 1306a has the same area as electrode 1306b, and electrodes 1306a and 1306b may be rigidly coupled to the bottom layer 1302.

In the equilibrium position 1300, the first electrode 1306a is vertically offset upward relative to the proof mass segment 1312a, and the second electrode 1306b is vertically offset downward to the proof mass segment 1312c. Segment 1312b is offset downward to the first electrode 1306a on the left side, and offset upwards to the second electrode 1306b on the right side. As shown in FIG. 13, this is achieved by aligning the bottoms of the proof masses and the bottoms of the electrodes 1306a and 1306b, and etching a gap of distance 1210 shown at 1304. This gap may be approximately 4 μm deep.

At 1320, the proof mass 1312 has moved in the vertical z direction as indicated by the arrow 1322. At 1320, the proof mass 1312 may have reached its maximum positive displacement in the z direction. At 1340, the proof mass 1312 has moved in the negative z direction as indicated by the arrow 1342. At 1340, the proof mass 1312 may have reached its minimum negative z displacement. As the proof mass 1312 oscillates in the z direction, it may move from position 1320, to position 1300, to position 1340, and then back to 1300 and 1320 to complete a full oscillation cycle.

As the proof mass moves in the directions indicated at 1322 and 1342, one electrode's capacitance will increase and the other electrode's capacitance will decrease. For example, as proof mass 1312 lowers, the second electrode 1306b that has a downward offset will approach a maximum capacitance when the second electrode 1306b and the proof mass 1312 are aligned. The first electrode 1306a, which has an upward offset, will have a decrease capacitance as the electrode's vertical separation from the proof mass 1312 increases. The converse is true as the proof mass 1312 moves in the positive z direction. As a specific upward position, the first electrode 1306a's capacitance will have a maximum, and at a specific downward vertical position, the second electrode 1306b will have a maximum. At each of these maxima, the slope of the capacitance with respect to time will be zero as the proof mass translates in the z direction. Because these zero-slope points correspond to fixed proof mass positions, an algorithm, such as the Cosine algorithm, as discussed with reference to FIG. 12, is able to use these points to determine acceleration.

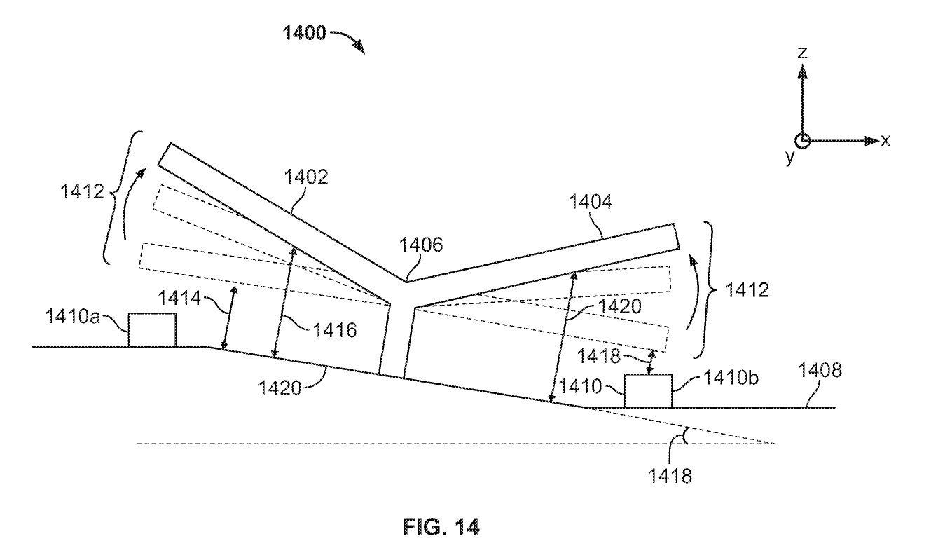

FIG. 14 depicts differential mode vertical movement of a multiple degrees of freedom inertial sensor with packaging deformations, according to an illustrative implementation. The motion shown in FIG. 14 is that of the first, lower natural frequency mode of the two-degree-of-freedom system. FIG. 14 shows a central anchor 1406 which is rigidly coupled to the bottom layer 1408 of the multiple degrees of freedom inertial sensor 1400. A first sense mass 1402 and a second sense mass 1404 may be mechanically coupled to the central anchor 1406 with springs (not shown). A package deformation 1420 may cause a tilt in the bottom layer 1408 of the multiple degrees of freedom inertial sensor, shown by the angle 1418. Sense electrodes 1410a and 1410b may sense the oscillations and perturbations of the sense masses 1402 and 1404 in the z direction, respectively, by detecting changes in capacitance between electrodes 1410a and 1410b, and electrodes located on the undersides of the sense masses 1402 and 1404. The sense masses 1402 and 1404 may be mechanically driven with drive combs (not shown) for example, as discussed in more detail with reference to FIG. 1. As each sense mass 1402 and 1404 oscillates, it moves up and down in the z direction as shown at 1412, going from minimum distances 1414 and 1418 from the sense electrode 1410a and 1410b, respectively, to maximum distances 1416 and 1420 from the sense electrode 1410a and 1410b, respectively, in one half cycle. The sense electrodes 1410a and 1410b may be any TDS structure, and may be one of the TDS structures described in FIGS. 1-13, capable of sensing oscillations and perturbations in the vertical direction. As shown in FIG. 14, the package deformation may cause a tilt 1418 in the anchoring structure 1406, which may result in uneven oscillation of the sense mass 1402 from 1404. As shown in FIG. 14, this may result in sense mass 1402 having a larger minimum distance 1414 from the sense electrode 1410a than the sense mass 1404's minimum distance 1418 from the sense electrode 1410b. The tilt angle 1418 may also lead to the sense mass 1402 having a larger maximum distance 1416 from the sense electrode 1410a than the sense mass 1404's maximum distance 1420 from the sense electrode 1410b. The difference in these minimum and maximum distances between sense masses 1402 and 1404 may result in common mode error in the electrical signals produced by the sense electrodes 1410a and 1410b as a result of the oscillations of sense masses 1402 and 1404.

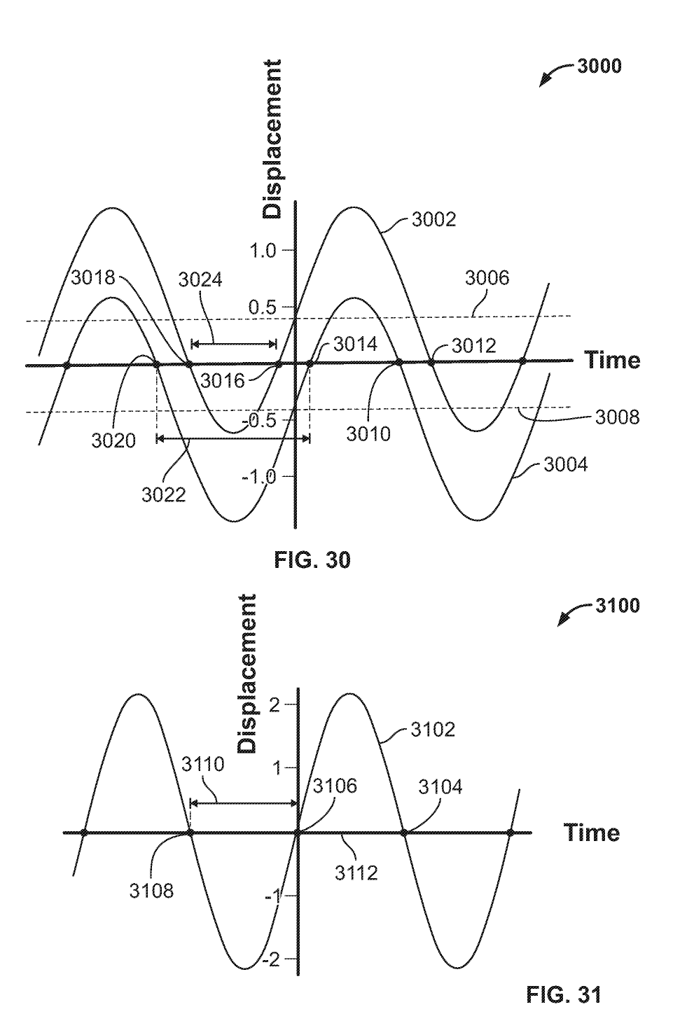

The common mode error that results from tilt 1418 may be removed as a result of the differential motion of sense masses 1402 and 1404, as shown in FIG. 14. Examples of the removal of package deformation or other common mode error from the differential motion of the two degree of freedom inertial sensor 1400 are discussed in more detail with reference to FIGS. 30 and 31.

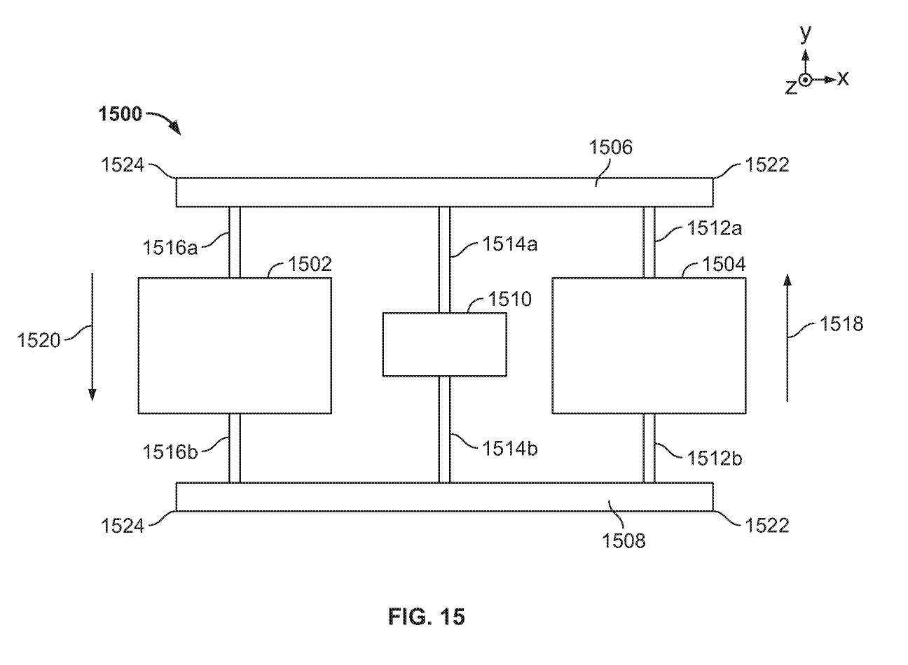

FIG. 15 depicts an overhead view of a multiple degrees of freedom inertial sensor for measuring perturbations in a horizontal plane, according to an illustrative implementation. The multiple degree of freedom inertial sensor 1500 is shown with two sense masses 1502 and 1504, which are each mechanically coupled to a frame 1506 and 1508 with coupling springs 1516a, 1516b, 1512a and 1512b respectively. The frame 1506 and 1508 is mechanically coupled to a central anchor 1510 with anchoring springs 1514a and 1514b. The central anchor 1510 may be rigidly coupled to a bottom layer (not shown) of the multiple degrees of freedom inertial sensor 1500. The sense masses 1502 and 1504 may oscillate in a differential mode as indicated by arrows 1520 and 1518, where, for example, the sense mass 1502 may move in a negative y direction at the same time that the sense mass 1518 moves in a positive y direction. The differential motion shown by arrows 1518 and 1520 is that of the first, lower natural mode frequency response of the two-degree-of-freedom system. Common mode motion, where the sense masses 1502 and 1504 move in the same direction, will be at the second, higher natural frequency mode of the system. The sense masses 1502 and 1504 may be driven with comb drives or any other drive structure capable of producing the oscillating motion as indicated by arrows 1520 and 1518. TDS sensors, described in further detail with reference to FIGS. 9-13 and 16 may convert the oscillation of sense masses 1520 and 1504 to an electrical signal capable of sensing perturbations such as acceleration of the multiple degrees of freedom inertial sensor 1500 in the horizontal plane.

The springs 1516a, 1516b, 1512a, and 1512b will each have a spring constant that, together with the mass of sense masses 1520 and 1504, and the mass of the frame 1506 and 1508, will define the resonant frequency of sense mass 1520 and 1504. The spring constant of springs 1512a, 1512b, 1516a and 1516b may all be the same. The spring constant of springs 1512a, 1512b, 1516a and 1516b may be lower than the spring constant of springs 1514a and 1514b. The spring constants and masses of the multiple degrees of freedom inertial sensor 1500 may be adjusted to lower the differential frequency mode of sense masses 1502 and 1504, as well as to favor the differential motion indicated by arrows 1520 and 1518. The springs 1512a and 1512b, 1514a, 1514b, 1516a, 1516b, may have a lower effective spring constant in response to the differential, out-of-phase motion of sense masses 1502 and 1504 than to the common mode, in-phase motion of sense masses 1502 and 1504. The lower, natural frequency mode response of the system shown in FIG. 15 may thus be associated with differential motion of the sense masses, while the second, higher natural frequency mode response of the system may be associated with common mode motion of the sense masses.

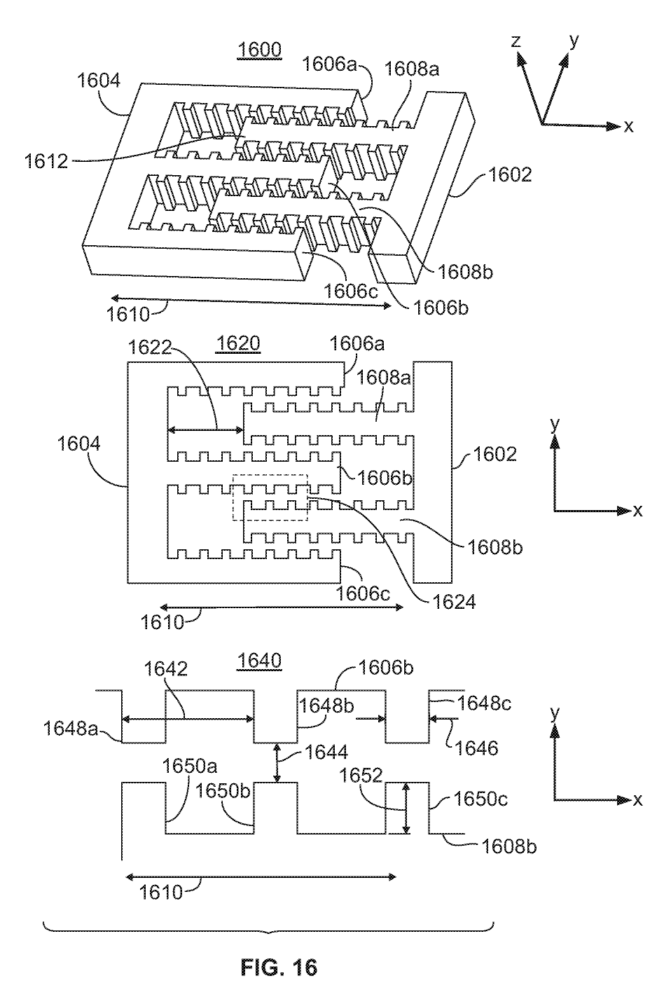

One end of the frame 1522 may move differentially with respect to the other end of the frame 1524, so that as the sense masses 1502 and 1504 oscillate differentially as indicated by the arrows 1520 and 1518, the frame 1506 and 1408 will oscillate with the same differential motion. Thus as the sense mass 1504 moves in the positive y direction, the end 1522 will also move in the positive y direction. As the sense mass 1502 moves in the negative y direction, the end 1524 will also move in the negative y direction. The differential motion of the sense masses 1502 and 1504 may be differentially sensed with in and out of phase TDS structures as described in further detail with reference to FIG. 16. The frame 1506, 1508, and sense masses 1502 and 1504 may be driven with a drive structure (not shown) as discussed in further detail with reference to FIG. 1.

The multiple degrees of freedom inertial sensor 1500 allows for differential motion of two sense masses in the horizontal plane. The frame 1522 as shown, allows for the coupling of sense masses necessary to produce a system with multiple resonant frequencies, while still allowing for differential motion of the sense masses in the horizontal plane.

FIG. 16 depicts three views, each showing a schematic representation of movable and fixed elements of a plurality of time-domain switches used to sense perturbations of a multiple degrees of freedom inertial sensor in a horizontal plane, according to an illustrative implementation. The sense mass of a multiple degrees of freedom inertial sensor can be coupled to the movable element 1602, while the fixed element 1604 may be rigidly coupled to the bottom layer of the multiple degrees of freedom inertial sensor. The movable element 1602 and the fixed element 1604 each include a plurality of interdigitated, equally spaced beams. In FIG. 16, the fixed element 1604 includes beams 1606a, 1606b and 1606c (collectively, beams 1606). The movable element 1602 includes beams 1608a and 1608b, and is separated from the fixed element 1604 in the x direction by a distance 1622. The distance 1622 will increase and decrease as the movable element 1602 oscillates with respect to the fixed element 1604 in the x direction. The distance 1622 is selected to minimize parasitic capacitance when the movable element 1602 is in the rest position, while also taking into consideration the ease of manufacturing the structure 1600. The view 1640 depicts an area of interest noted by the rectangle 1624 of view 1620. 1620 is an overhead view of the perspective view shown at 1600.

Each of the beams 1606 and 1608 includes multiple sub-structures, or teeth, protruding in a perpendicular axis to the long axis of the beams (shown in FIG. 16 as they and x axis, respectively). The beam 1606b includes teeth 1648a, 1648b, and 1648c (collectively, teeth 1648). The beam 1608b includes teeth, 1650a, 1650b and 1650c (collectively, teeth 1650). Adjacent teeth on a beam are equally spaced according to a pitch 1642. Each of the teeth 1648 and 1650 has a width defined by the line width 1646 and a depth defined by a corrugation depth 1652. Opposing teeth are separated by a tooth gap 1654. As the movable beam 1606b oscillates along the axis 1610 with respect to the fixed beam 1606b, the tooth gap 1644 remains unchanged.

A capacitance may exist between the fixed beam 1606b and the movable beam 1608b coupled to the sensing mass. As the movable beam 1608b oscillates along the axis 1610 with respect to the fixed beam 1606b, this capacitance will change. As the teeth 1650a, 1650b and 1650c align with opposing teeth 1648a, 1648b and 1648c respectively, the capacitance will increase. The capacitance will then decrease as these opposing sets of teeth become less aligned with each other as they move in either direction along the x-axis. At the position shown in view 1640, the capacitance is at a maximum as the teeth 1650 are aligned with teeth 1648. As the moveable beam 1602 moves monotonically along the axis 1610, the capacitance will first gradually decrease and then gradually increase as the Nth moving tooth becomes less aligned with the Nth fixed tooth, and then aligned with the (N±i)th fixed tooth, where i=1, 2, 3, 4 . . . iₘₐₓ This process is repeated for the full range of motion for the Nth tooth, where the minimum of the sense mass's displacement occurs at the (N−iₘₐₓ)th fixed tooth, and the maximum of the sense mass's displacement occurs at the (N+iₘₐₓ)th fixed tooth.

The capacitance may be degenerate, meaning that the same value of capacitance occurs at multiple displacements of the moveable beam 1608b. For example, the capacitance value when the Nth moving tooth is aligned with the (N+1)th fixed tooth may be the same when the Nth moving tooth is aligned with the (N+2)th fixed tooth. Thus when the moveable beam 1608b has moved from its rest position by a distance equal to the pitch 1642, the capacitance is the same as when the moveable beam 1608b is in the rest position.

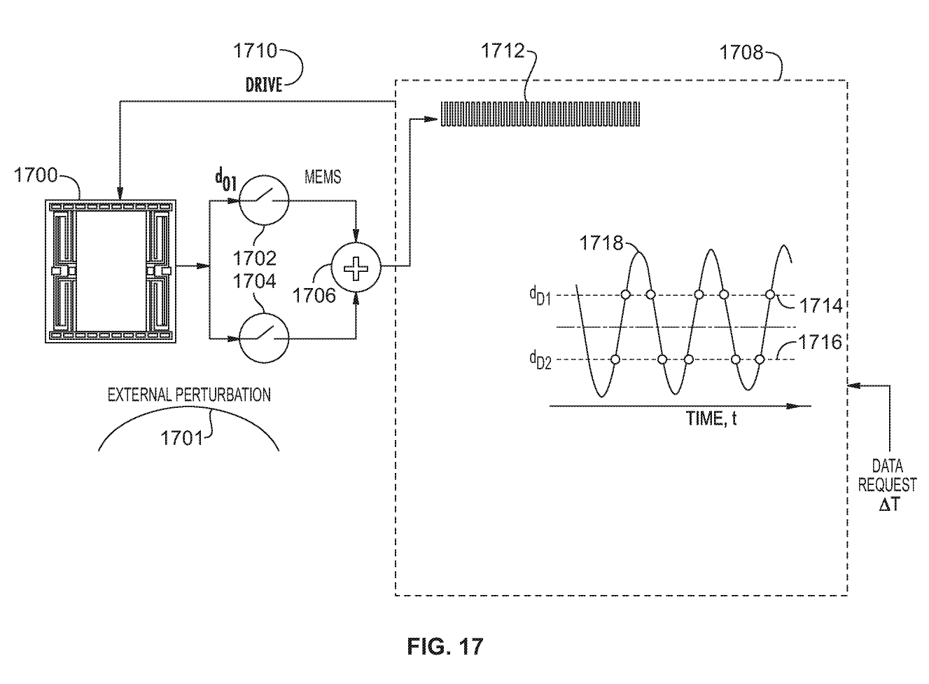

FIG. 17 depicts a process for extracting inertial information from an inertial sensor, according to an illustrative implementation FIG. 17 includes a representative inertial sensor 1700 which experiences an external perturbation 1701. This inertial sensor may be an accelerometer, a gyroscope, a multiple degrees of freedom inertial sensor, or any other sensor capable of producing the signals shown in FIG. 17 and able to detect an inertial parameter. A drive signal 1710 causes a moveable portion of the multiple degrees of freedom inertial sensor 1700 to oscillate. This moveable portion of the multiple degrees of freedom inertial sensor 1700 may be the sense mass. An analog frontend (AFE) electrically connected to a moveable element and a fixed element of a TDS structure of the inertial sensor measures the capacitance between them and outputs a signal based on this capacitance. The AFE may measure capacitive current or a charge. Zero-crossings of the AFE output signal occur when the AFE output signal momentarily has a magnitude of zero. Zero-crossings of an output signal from the inertial sensor 1700 are generated at 1702 and 1704 and combined at 1706 into a combined signal. A signal processing module 1708 processes the combined analog signal to determine inertial information. One or more processes can convert the combined analog signal into a rectangular waveform 1712. This may be done using a comparator, by amplifying the analog signal to the rails, or by other methods.

The rectangular waveform 1712 has high and low values, with no substantial time spent transitioning between them. Transitions between high and low values correspond to zero-crossings of the combined analog signal. The transitions between high and low values and zero-crossings occur when a displacement 1718 of the sense mass crosses reference levels 1714 and 1716. The reference levels 1714 and 1716 correspond to physical locations along the path of motion of the sense mass. Because the zero-crossings are associated with specific physical locations, displacement information can be reliably determined independent of drift, creep and other factors which tend to degrade performance of inertial sensors.

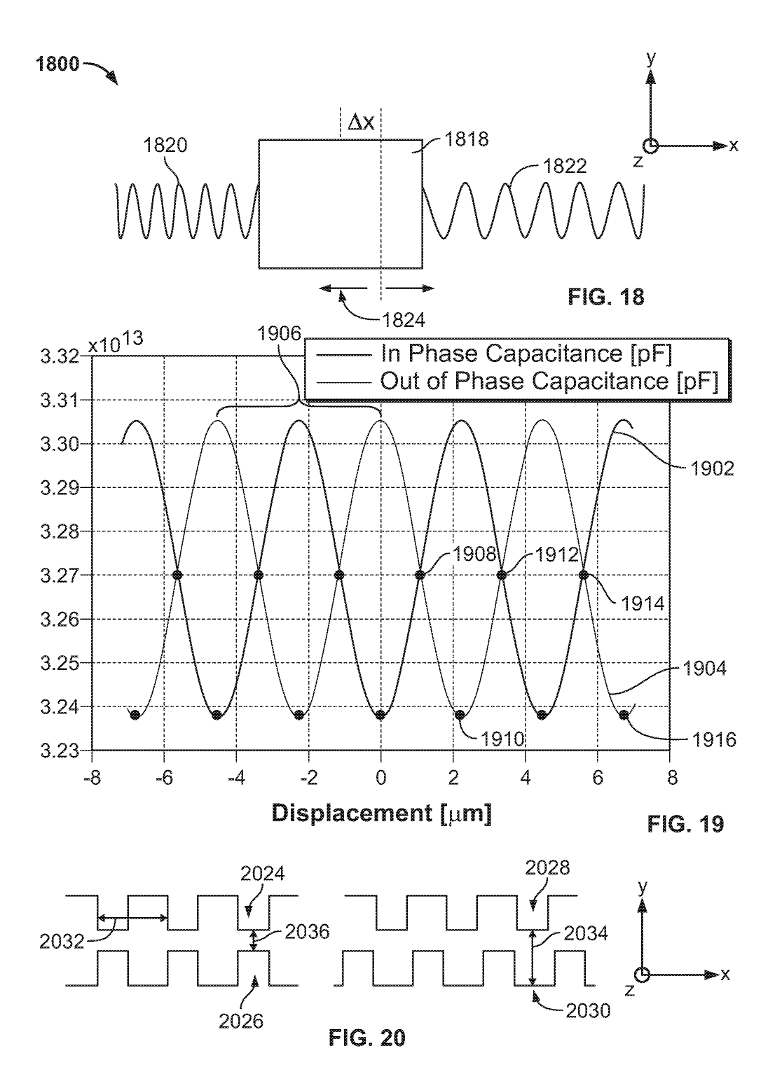

FIG. 18 depicts a conceptual schematic of a one degree of freedom sense mass' oscillation, according to an illustrative implementation. A sense mass 1818 is attached to springs 1820 and 1822, which may be coupled to a drive mass, and which each compress or extend as the sense mass 1818 oscillates in the axis of displacement 1824. The spring constants of springs 1820 and 1822 will determine the force extension relationship of the proof mass. This can be modeled by Hooke's law, whereby the force F applied to the sense mass results in displacement Δx according to the relation:

F=kΔx (4)

Thus as an inertial force is applied to the sense mass, it will respond with a displacement Δx that may be measured by a change in capacitance or any other electrical signal relating the physical displacement to a measurable output. The k value or spring constant of a multiple degrees of freedom inertial sensor is determined by the geometry of the springs. The geometric and fabrication considerations for determining this spring constant are discussed in more detail with reference to FIG. 1-8.

FIG. 19 is a graph showing the in phase and out of phase capacitive response to a sense mass oscillation produced by TDS structures of a multiple degrees of freedom inertial sensor, according to an illustrative implementation. FIG. 19 demonstrates the translation of the linear displacement of a sense mass into a non-linear electrical signal. An in-phase signal 1904 may be generated by TDS geometry that maximizes capacitance at a sense mass' resting position. An out of phase signal 1902 may be generated by TDS geometry that minimizes capacitance at a sense mass' resting position. An in-phase and an out of phase signal may be separated by a phase difference of 90° as is shown at FIG. 19, or any other phase difference desired. The in phase 1904 and out of phase 1902 signals may result from the displacement of the same sense mass, such that the moveable components of the TDS structures that generate signals 1904 and 1902 are both coupled to the same sense mass. The in phase 1904 and out of phase 1902 signals may be subtracted, averaged, or otherwise combined to produce a single measurement reflective of a proof mass displacement. This measurement may be based on time intervals produced by zero-crossings of an analog electrical signal output by the TDS structures shown. The period 1906 of an in phase signal 1904 may be determined entirely by the geometry of the TDS teeth. The in phase 1904 and out of phase 1902 signals may have the same zero crossings as shown at 1908, 1912 and 1914.

FIG. 20 depicts in phase and out of phase TDS structures for sensing perturbations in a horizontal plane, according to an illustrative implementation. Both moveable elements 2026 and 2030 are shown in at their resting equilibrium without inertial forces or drive forces acting on either of them. The pitch or distance between teeth 2032 defines the distance between peaks of capacitance, or the phase of the resulting nonlinear capacitive signal. A voltage may be applied between fixed element 2024 and moveable element 2026, as well as between fixed element 2028 and moveable element 2030. The distance 2036 between fixed element 2024 and moveable element 2026 defines a minimum distance between teeth corresponding to a maximum of capacitance. The distance 2034 between fixed element 2028 and moveable element 2030 defines a maximum distance between teeth corresponding to a minimum of capacitance. As moveable elements 2034 and 2036 oscillates linearly in the axis 2038, the capacitance between teeth will oscillate between the minimum “aligned” state where the distance between teeth is 2036, and the non aligned state where the distance between teeth is 2034. This will in turn produce an electrical signal as discussed in detail with reference to FIG. 19. The moveable elements 2026 and 2030 may be coupled to the same sense mass, such that the electrical signal produced between elements 2024 and 2026, and 2028 and 2030 will correspond to the same physical displacement. The fixed elements 2028 and 2024 may be rigidly coupled to a support structure or other anchoring architecture of the composite mass inertial sensor.

Signals generated from in phase structures 2024 and 2026, and out of phase structures 2028 and 2030 may be linearly combined to produce differential signals. Differential signals may be produced by subtracting a signal produced by 2024 and 2026 from a signal produced by 2028 and 2030. This differential signal may eliminate common mode error produced by parasitic capacitance, temperature variations, packaging deformations, ground loops, drifts in voltage bias, or any other sources of electrical error that may affect both signals.

FIG. 21 is a graph representing the relationship between analog signals derived from a multiple degrees of freedom inertial sensor and the displacement of a sense mass of a multiple degrees of freedom inertial sensor, according to an illustrative implementation. The graph 2100 represents signals derived from an oscillator in which opposing teeth are aligned at the rest position, as described in further detail with reference to FIG. 20. This oscillator may be the sense mass of a multiple degrees of freedom inertial sensor coupled to a TDS structure. The graph 2100 includes curves 2102, 2104, and 2106. The curve 2102 represents an output of an AFE such as a transimpedence amplifier (TIA). Since a TIA outputs a signal proportional to its input current, the curve 2102 represents a capacitive current measured between moveable and fixed elements of a multiple degrees of freedom inertial sensor. The curve 2106 represents an input acceleration applied to the accelerometer. The input acceleration represented by curve 1206 is shown as a 15 g acceleration at 20 Hz, but may be any outside perturbation, force or acceleration. The curve 2104 represents displacement of the sense mass of a composite mass inertial sensor.

FIG. 21 includes square symbols indicating points at which the curve 2102 crosses zero. Since capacitive current 2102 is proportional to the first derivative of capacitance, these zero-crossings in the current represent local maxima or minima (extrema) of capacitance between a moveable element and a fixed element of the multiple degrees of freedom inertial sensor. FIG. 21 includes circular symbols indicating points on the curve 2104 corresponding to times at which curve 2102 crosses zero. The circular symbols indicate the correlation between the physical position of a moveable element of the multiple degrees of freedom inertial sensor and zero-crossing times of the outputs of the signal 2102.

At the time 2118, the curve 2102 crosses zero because the displacement 2104 of the moveable element of the sense mass is at a maximum and the oscillator is instantaneously at rest. Here, capacitance reaches a local extremum because the moveable element has a velocity of zero, not necessarily because teeth or beams of the oscillator are aligned with opposing teeth or beams. At time 2120, the TIA output curve 2102 crosses zero because the oscillator displacement reaches the +d₀ location 2108. The +d₀ location 2108 corresponds to a displacement in a positive direction equal to the pitch distance and is a point at which opposing teeth or beams are aligned to produce maximum capacitance.

At time 2122, the TIA output curve 2102 crosses zero because the movable element of the oscillator is at a position at which the teeth are anti-aligned. This occurs when the teeth of the movable element are in an aligned position with the centers of gaps between teeth of the fixed element, resulting in a minimum in capacitance. This minimum in capacitance occurs at a location of +d₀/2 1210, corresponding to a displacement of one-half the pitch distance in the positive direction.

At time 2124, the TIA output curve 2102 crosses zero because teeth of the movable element are aligned with teeth of the fixed element, producing a maximum in capacitance. The time 2124 corresponds to a time at which the movable element is at the rest position, indicated by the zero displacement 2112 on the curve 2104. At time 2126, the TIA output 2102 crosses zero because teeth of the movable element are once again anti-aligned with teeth of the fixed element, producing a local minimum in capacitance. This anti-alignment occurs at a displacement of −d₀/2 2114, corresponding to a displacement of one-half the pitch distance in the negative direction.

At time 2128, the TIA output 2102 crosses zero because the teeth of the movable element are in an aligned position with respect to the teeth of the fixed element, creating a local maximum in capacitance. This local maximum in capacitance occurs at a displacement of −d₀ 2116, corresponding to a displacement of the pitch distance in the negative direction. At time 2130, the TIA output curve 2102 crosses zero because the movable element has an instantaneous velocity of zero as it reverses direction. This reversal of direction is illustrated by the displacement curve 2104. As at time 2118, when the movable element has a velocity of zero, capacitance does not change with time and thus the current and TIA output (which are proportional to the first derivative of capacitance) are zero.

FIG. 22 is a graph illustrating a current response to the displacement of a sense mass of a multiple degrees of freedom inertial sensor, according to an illustrative implementation. The graph 2200 includes a current curve 2202 and a displacement curve 2204. The current curve 2202 represents an input signal for a TIA and may be produced by TDS structures coupled to a sense mass of a multiple degrees of freedom inertial sensor. The TIA may produce an output signal such as the TIA output curves 2102 as shown in FIG. 21 in response to displacement of the sense mass of a multiple degrees of freedom inertial sensor. The current curve 2202 is a capacitive current generated between fixed and movable elements of the multiple degrees of freedom inertial sensor in response to displacement 2204. The current curve 2202 crosses zero at numerous times, including times 2224, 2226, 2228, and 2230. At the times 2224 and 2230, the movable element has a displacement of −d₀, where d₀ may correspond to the pitch distance between teeth of a TDS structure. At the times 2226 and 2228, the movable element has a displacement of +d₀.

The graph 2200 includes two time intervals T₄₃ 2232 and T₆₁2234. The time interval T₄₃ 2232 corresponds to the difference in time between time 2226 and time 2228. The time interval T₆₁ 2234 corresponds to the time difference between times 2224 and 2230. Thus, time interval T₆₁ 2234 corresponds to the time between subsequent crossings of the −d₀ 2216 location, and the time interval T₄₃ 2232 corresponds to the time interval between subsequent crossings of the +d₀ 2208 location. The methods used to determine the time intervals T₄₃ 2232 and T₆₁ 2234 can be used to determine other time intervals, such as between a crossings of the +d₀ 2208 and the next subsequent crossing of the −d₀ 2216 level, between a time interval between a crossing of the −d₀ 2416 level and the next crossing of the +d₀ 2208 level, between the time 2230 and the next crossing of the +d₀ 2208 level, between crossings of the zero 2212 level, between zero-crossings due to a maximum or minimum of displacement, or between any other combination of zero-crossings of the current curve 2202 or a TIA output signal corresponding to the current curve 2202.

FIG. 23 is a graph showing a rectangular-wave signal produced from zero-crossing times of the current signal depicted in FIG. 22, according to an illustrative implementation. The graph 2300 includes a rectangular waveform curve 2336. The rectangular waveform curve 2336 has substantially two values: a high value and a low value. While the rectangular waveform curve 2336 may have intermediate values as it transitions between the high and low values, the time spent at intermediate values is far less than the combined time spent at the high and low of the values.

The rectangular waveform curve 2336 can be produced by a variety of methods, including using a comparator to detect changes in an input signal, by amplifying an input signal to the limits of an amplifier so as to saturate the amplifier (amplifying to the rails), by using an analog-to-digital converter, and the like. One way to produce this rectangular waveform curve 2336 from the current curve 2202 shown in FIG. 22 is to use a comparator to detect zero-crossings of the current curve 2202. When the current curve 2202 has a value greater than a reference level (such as zero), the comparator outputs a high value, and when the current curve 2202 has a value less than the reference level (such as zero), the comparator has a low value. The comparator's output transitions from low to high when the current curve 2202 transitions from a negative value to a positive value, and the comparator's output transitions from high to low when the current curve 2202 transitions from a positive value to a negative value. Thus, times of rising edges of the rectangular waveform curve 2336 correspond to times of negative-to-positive zero-crossings of the current curve 2304, and falling edges of the rectangular waveform curve 2336 correspond to positive-to-negative zero-crossings of the current curve 2202. This can be seen at time 2324, where the rectangular waveform curve 2336 transitions from a negative to positive value, corresponding to a zero crossing at 2224 in FIG. 22. The same can be seen at time 2328 corresponding to zero crossing 2228. The rectangular waveform curve 2336 transitions from a positive value to a negative value at times 2326 and 2330, corresponding to a zero crossing at 2226 and 2230 in FIG. 22, respectively.

The rectangular waveform curve 2336 includes the same time intervals 2232 and 2234 as the current curve 2202. One benefit of converting the current curve 2202 to a rectangular waveform signal such as the rectangular waveform curve 2336 is that in a rectangular waveform signal, rising and falling edges are steeper. Steep rising and falling edges provide more accurate resolution of the timing of the edges and lower timing uncertainty. Another benefit is that rectangular waveform signals are amenable to digital processing.

FIG. 24 is a graph showing time intervals produced from non-zero crossing reference levels, according to an illustrative implementation. The graph 2400 includes times 2436 and 2438. The graph 2400 includes the time interval T₉₄ 2440 and the time interval T₇₆ 2442, which represent crossing times of the displacement curve 2404 of reference levels 2408 and 2416 respectively. The time interval T₉₄ 2440 corresponds to the time interval between times 2428 and 2438. The time interval T₇₆ 2442 corresponds to the time interval between times 2430 and 2436. The graph 2400 also includes time interval T₄₃ 2432 and T₆₁2434, corresponding to a time interval between times 2426 and 2428, and 2424 and 2430, respectively. The reference levels, shown at 2408, 2412, and 2416 may be any value within the displacement range of the sense mass. The reference levels 2408, 2412 and 2416 may be predetermined, and may correspond to the physical geometry of a TDS structure, such as the pitch distance between teeth.

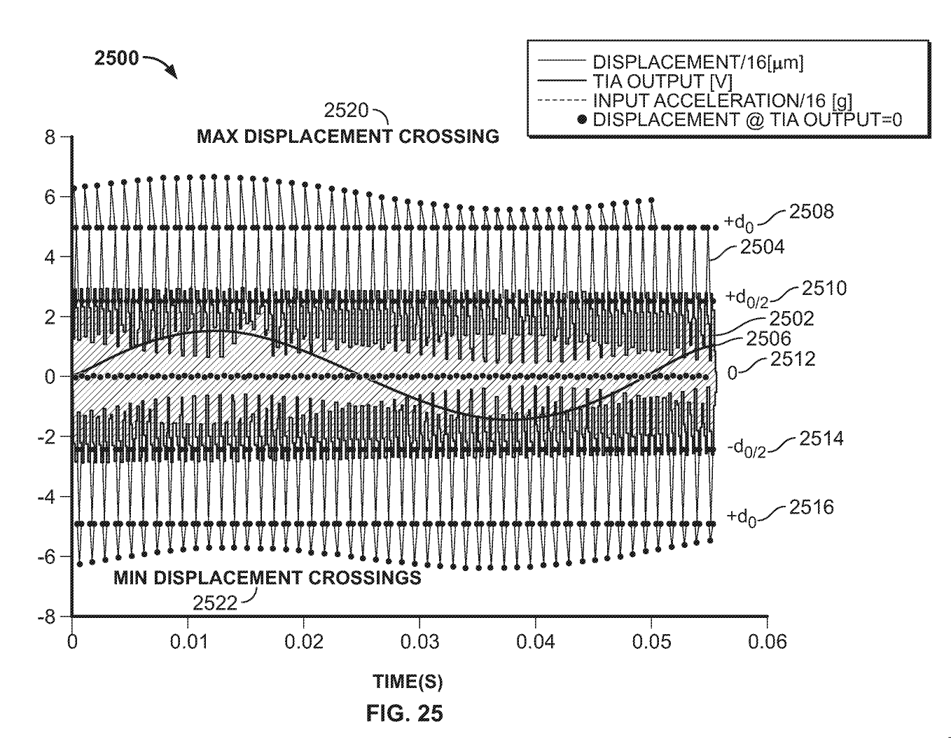

As can be seen with reference to FIG. 25, the sense mass displacement as shown by the displacement curve 2504 experiences an offset that is correlated with input acceleration as indicated by the acceleration curve 2506. Thus, one way to detect shifts of the displacement of a sense mass and thus input acceleration is to compare relative positions of zero-crossing times of a displacement curve produced by the sense mass. As shown in FIG. 24, a sum of the time intervals T₄₃ 2432 and T₉₄ 2440 represents a period of oscillation as does a sum of the periods T₆₁ 2434 and T₃₆ 2442. In comparing a subset of the period, such as comparing the time interval T₄₃ 2432 with the sum of T₄₃ 2432 and T₉₄ 2440 represents the proportion of time that the sense mass spends at a displacement greater than +d₀ 2408. An increase in this proportion from a reference proportion indicates a greater acceleration in a positive direction than the reference. Likewise, a decrease in this proportion from the reference indicates a greater acceleration in the negative direction. Other time intervals can be used to calculate other proportions and changes in acceleration.

In some examples, integrating portions of the rectangular waveform using the systems and methods described herein can be performed to determine relative positions of zero-crossing times and thus acceleration, rotation and/or velocity. In other examples, displacement of a sense mass can be determined from the time intervals depicted in FIG. 24 using equations (5), (6), and (7).

$$\begin{matrix}d = \frac{2 {d}_{0} cos ( π \frac{{T}_{61}}{{P}_{m 1}} )}{cos ( π \frac{{T}_{61}}{{P}_{m 1}} ) - cos ( π \frac{{T}_{43}}{{P}_{m 2}} )} - {d}_{0} & ( 5 ) \\ {P}_{m 1} = {T}_{61} + {T}_{76} & ( 6 ) \\ {P}_{m 2} = {T}_{43} + {T}_{94} & ( 7 )\end{matrix}$$

Displacement of the sense mass can be converted to an acceleration using Hooke's Law (shown in equation (4)). Displacement of the sense mass can be calculated recursively for each half cycle of the sense mass. Using this information, the displacement of the sense mass can be recorded as a function of time. This allows the calculation of external perturbations with zero drift and lower broadband error.

In some examples, the out-of-plane sensor includes periodic capacitive sensors, in which the capacitance between the sense mass and a fixed portion of the sensor varies non-monotonically as a function of z(t), which represents the out-of-plane displacement of the sense mass. This non-linear capacitive variation may be known, repeatable, and periodic. The non-linear capacitance produced by a single electrode may be modeled by a trigonometric or otherwise periodic function. The non-linear capacitance may be shown as:

$$\begin{matrix}{S}_{MAP} ( t ) = {C}_{0} + {C}_{1} \cdot sin [ \frac{2 π}{P} \cdot x ( t ) ] \\ = {C}_{0} + {C}_{1} \cdot sin [ \frac{2 π}{P} \cdot ( A sin ( {ω}_{d} t ) + Δ ) ]\end{matrix} \qquad ( 8 )$$

Where C₀ and C₁ are constants that may be defined by the geometry of the sense electrodes, P is a period such as those give by equations (6) and (7), and ω_{d} is a frequency of oscillation in the out-of-plane direction. Using equation (5), one may utilize the relationship between capacitance and displacement to model the displacement by a periodic function, such as the following:

z(t)=A sin(ω_{d}t)+Δ (9)

Measurements of capacitance, given in equation (5), may thus allow one to solve for the variables in equation (6), such as frequency ω_{d}, offset Δ, amplitude A and displacement z(t). By repeatedly solving for these variables, the amplitude, frequency and offset of the motion of the sense mass can be determined with respect to time. The offset may be proportional to the external acceleration or other perturbing forces of measurement interest.

To obtain these parameters, the times at which the out-of-plane sensor has predetermined values of capacitance are measured. At these times, the sense mass is known to be at a position that is given by equation (10), where n is a positive integer.

$$\frac{2 π}{P} \cdot z ( t ) = n \cdot π \qquad ( 10 )$$

The oscillator is known to be at a displacement that is a multiple of P/2, where P is a period that may be given, for example, by equations (6) or (7), by tracking the number of times at which the capacitance equals the predetermined capacitance. The number of times at which the oscillator crosses displacements of P/2 can be tracked to overcome issues of degeneracy in capacitance. In particular, successive times at which the oscillator displacement equals +P/2 and −P/2 (δt and δt−, respectively) are measured and used to solve for A, ω_{d}, and Δ. Equation (11) shows the calculation of ω_{d} as a function of the time intervals.

$${ω}_{d} = \frac{2 π}{Period} = 2 π \frac{2}{( δ {t}_{1}^{+} + δ {t}_{2}^{+} + δ {t}_{1}^{-} + δ {t}_{2}^{-} )} \qquad ( 11 )$$

Exploiting the similarity of the measured time intervals combined with the fact that all time measurements were taken at points at which the capacitance equaled known values of capacitance and the oscillator displacement equaled integral multiples of P/2, the system of equations (12) and (13) can be obtained.

$$\begin{matrix}z ( t ) = + \frac{P}{2} = A \cdot cos ( {ω}_{d} \frac{δ {t}_{1}^{+}}{2} ) + Δ & ( 12 ) \\ z ( t ) = - \frac{P}{2} = A \cdot cos ( {ω}_{d} \frac{δ {t}_{1}^{-}}{2} ) + Δ & ( 13 )\end{matrix}$$

The difference of equations (6) and (7) allows the amplitude A to be determined as in equation (14).

$$A = \frac{P}{cos ( {ω}_{d} \frac{δ {t}_{1}^{+}}{2} ) - cos ( {ω}_{d} \frac{δ {t}_{1}^{-}}{2} )} \qquad ( 14 )$$

The sum of the equations (6) and (7) allows the offset Δ to be determined as in equation (15).

$$Δ = - \frac{A}{2} \cdot [ cos ( {ω}_{d} \frac{δ {t}_{1}^{+}}{2} ) + cos ( {ω}_{d} \frac{δ {t}_{1}^{-}}{2} ) ] \qquad ( 15 )$$

In some examples, an excitation field itself is varied with time. For example one or more of the components is attached to a compliant structure but is not actively driven into oscillation. Instead, the time varying signal is generated by varying, for example, voltage between the components. External perturbations will act on the compliant component, causing modulation of the time-varying nonlinear signal produced by the component.

Nonlinear, non-monotonic, time varying signals can be generated with a fixed set of electrically decoupled structures with which a nonlinear time-varying force of variable phase is generated. The time-varying force may be caused by the application of voltages of equal magnitude and different phase to each of the set of structures. This generates signals at phases determined by the phase difference of the applied voltages.

Sets of nonlinear signals with identical or differing phases can be combined to form mathematical transforms between measured output signals and system variables such as amplitude, offset, temperature, and frequency. Combinations of nonlinear signals with identical or differing phases can be included to minimize or eliminate a time varying force imparted on a physical system that results from measurement of the nonlinear signal. For example, two separate signals can be included within the system at 0° and 180° of phase, such that each signal is the inverse of the other. An example set of signals of this nature are the signals +A*sin(ωt) and −A*sin(ωt) for phases of 0° and 180° respectively.

Mathematical relationships between the periodic nonlinear signals and external perturbations can be applied to extract inertial information. For example, mathematical relationships can be applied in a continuous fashion based on bandwidth and data rates of the system. In some examples, mathematical relationships can be applied in a periodic sampled fashion. Mathematical relationships can be applied in the time or the frequency domains. Harmonics generated by the sensor can be utilized mathematically to shift frequency content to enable filtering and removal of lower frequency, drift-inducing noise. Harmonics can also be used to render the sensor insensitive or immune to these drift-inducing noise sources by applying one or more mathematical relationships to decouple the inertial signal from other system variables.

In some implementations, assist structures uniquely identify when external perturbations cause an offset in the physical structure of the device. Offsets can be integral or non-integral multiples of a pitch of tooth spacing. These assist structures are electrically isolated from one another and from the main nonlinear periodic signal.

To sense external perturbations in the z axis, normal to the plane of the wafer, corrugations may be formed on one or more surface of the sensor. In some examples, corrugated comb fingers are formed with height differences. In some examples, vertically corrugated teeth are formed in a self-aligned in-plane structure used for x or y axis sensing. In some examples, vertical corrugations are added to one or more plates of a capacitor.

In some examples, materials used to form the device may be varied spatially to result in a time-varying component of capacitance resulting from device motion. For example, oxides, other dielectrics, metals, and other semiconductors can be deposited or patterned with spatial variations. These spatial variations in dielectric constant will result in time variations of capacitance when components of the sensor are moved relative to each other. In some examples, both top and bottom surfaces of silicon used to form a proof mass include vertical corrugations. In some examples, both top and bottom cap wafers surrounding the device layer of silicon include vertical corrugations. In some examples, one or more of spatial variations in material, corrugation of the top of the device layer of silicon, corrugation of the bottom device layer of silicon, corrugation of the top cap wafer, and corrugation of the bottom cap wafer are used to form the sensor. In some examples, a vernier capacitor structure is used to form the sensor.

Signals output by the systems and methods described herein can include acceleration forces, rotational forces, rotational accelerations, changes in pressure, changes in system temperature, and magnetic forces. In some examples, the output signal is a measure of the variation or stability of the amplitude of a periodic signal, such as the oscillator displacement. In some examples, the output signal is a measurement in the variation or stability of the frequency of the periodic signal. In some examples, the output is a measurement of the variation or stability of the phase of the periodic signal. In some examples, the output signal includes a measurement of time derivatives of acceleration, such as jerk, snap, crackle, and pop, which are the first, second, third, and fourth time derivatives of acceleration, respectively.

In addition to measuring the inertial parameters from time intervals, in some examples, periodicity in physical structures is utilized to detect relative translation of one of the structures by tracking rising and falling edges caused by local extrema of capacitance, these local extrema of capacitance corresponding to translation of multiples of one half-pitch of the structure periodicity. The number of edges counted can be translated into an external acceleration. In some examples, an oscillation is applied to the physical structure, and in other examples, no oscillation force is applied to the physical structure.

A nonlinear least-squares curve fit, such as the Levenburg Marquardt curve fit, can be used to fit the periodic signal to a periodic equation such as equation (16).

A sin(Bt++Dt+E (16)

In equation (10), A represents amplitude, B represents frequency, C represents phase, E represents the offset of an external acceleration force, and D represents the first derivative of the external acceleration force, or the time-varying component of acceleration of the measurement. The measurement period is one-half of the oscillation cycle. Additionally, higher-order polynomial terms can be included for the acceleration as shown in equation (17).

A sin(Bt+C)+Dt³+Et²+Ft+G+ . . . (17)

In some examples, the input perturbing acceleration force can be modeled as a cosine function as shown in equation (18), in which D and E represent the amplitude and frequency of the perturbing acceleration force, respectably.

A sin(Bt+C)+D cos(Et) (18)

If the external perturbing acceleration is small in comparison to the internal acceleration of the oscillator itself, a linear approximation may be used to model the perturbing acceleration. In this case, the offset modulation is taken to be small in comparison to the overall amplitude of the generated periodic signal. By doing so, a measurement of a single time period can be taken to be linearly proportional to the external perturbing force. In some examples, multiple time periods may be linearly converted into acceleration and then averaged together to obtain lower noise floors and higher resolution.

In some examples, analysis in the frequency domain may be performed based on the periodic nature of the nonlinear signals being generated, as well as their respective phases. Frequency domain analysis can be used to reject common-mode noise. Additionally, the non-zero periodic rate of the signal can be used to filter out low frequency noise or to high-pass or band-pass the signal itself to mitigate low-frequency drift.

FIG. 25 is a graph showing the effects of an external perturbation on the output signal of the multiple degrees of freedom inertial sensor, according to an illustrative implementation. The graph 2500 includes the TIA output curve 2502, a displacement curve 2504, and an input acceleration curve 2506. FIG. 25 also depicts the reference pitch locations +d₀ 2508, +d₀/2 2510, 0 2512,−d₀/2 2514, and −d₀ 2516, where d₀ is the pitch between teeth of a TDS structure, as described in further detail with reference to FIG. 16. The graph 2500 depicts the same signals depicted in the graph 2400 of FIG. 24, with the x axis of 2500 representing a longer duration of time than is shown in the graph 2400. The periodicity of the input acceleration curve 2506 is more easily discerned at this time scale. In addition, maximum displacement crossings 2520 and minimum displacement crossings 2522 can be discerned in the graph 2500 to experience a similar periodicity. In contrast to the maximum displacement crossings 2520 and the minimum displacement crossings 2522, the amplitude of which varies with time, zero-crossings of the TIA output signal 2502 triggered by alignment or anti-alignment of teeth of the fixed and movable elements at the locations +d₀ 2508, +d₀/2 2510, 0 2512,−d₀/2 2514, and −d₀ 2516 are time invariant. These reference crossings, the amplitude of which are stable with time, provide stable, drift-independent indications of sense mass displacement and can be used to extract inertial parameters.

FIG. 26 is a graph depicting the capacitance as a function of the displacement of a sense mass of a multiple degrees of freedom inertial sensor, according to an illustrative implementation. FIG. 26 includes a capacitance curve 2602 that is periodic and substantially sinusoidal. Thus, monotonic motion of the movable element, such as described with reference to FIG. 16, produces a capacitance that changes non-monotonically with displacement. This non-monotonic change is a function of the geometric structure of the TDS structures shown with reference to FIG. 16, and the manner in which the multiple degrees of freedom inertial sensor is excited.

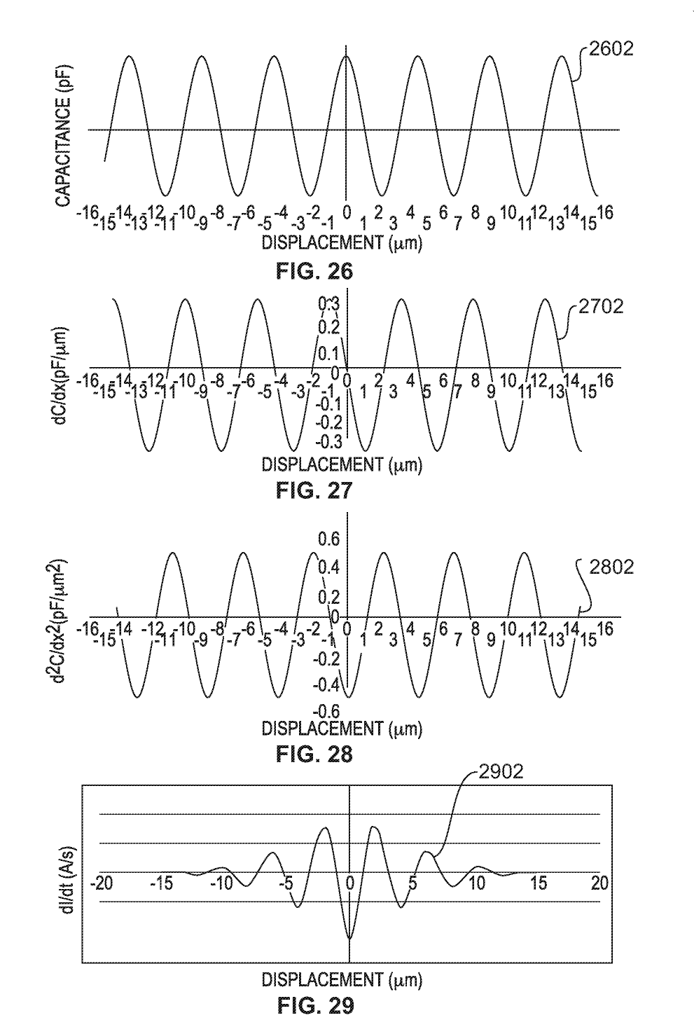

FIG. 27 is a graph depicting the first spatial derivative of capacitance as a function of the displacement of a sense mass of a multiple degrees of freedom inertial sensor, according to an illustrative implementation. FIG. 27 includes a dC/dx curve 2702 which is periodic and substantially sinusoidal. The dC/dx curve 2702 is the first derivative of the capacitance curve 2602. As such, the dC/dx curve 2702 crosses zero when the capacitance curve 2602 experiences a local extremum. Capacitive current is proportional to the first derivative of capacitance and thus proportional to, and shares zero-crossings with, the dC/dx curve 2702.

FIG. 28 is a graph depicting the second spatial derivative of capacitance as a function of the displacement of a sense mass of a multiple degrees of freedom inertial sensor, according to an illustrative implementation. FIG. 28 includes a d²C/dx² curve 2802. The dC/dx² curve 2802 is the first derivative of the dC/dx curve 2702 and as such has a value of zero at local extrema of the dC/dx curve 2702. The d²C/dx² curve 2802 indicates the slope of the dC/dx curve 2702 and thus indicates locations at which the current is most rapidly changing. In some implementations, it is desirable to maximize the amplitude of the d²C/dx curve 2802 to maximize the steepness of the current curve. This reduces uncertainty in resolving timing of zero-crossings of the current. Reducing uncertainty of the zero-crossing times results in decreased system error and decreased jitter, as well as, lower gain required of the system. Decreased jitter results in improved resolution of external perturbations. In some implementations, it is desirable to minimize the impact of variable parasitic capacitance, which is parasitic capacitance that varies with sense mass motion.

FIG. 29 is a graph depicting the time derivative of the capacitive current as a function of displacement of a sense mass of a multiple degrees of freedom inertial sensor, according to an illustrative implementation. FIG. 29 includes a dI/dt curve 2902. The capacitive current used to determine the dI/dt curve 2902 is obtained by applying a fixed voltage across the capacitor used to produce the capacitive curve 2602. The dI/dt curve 2902 represents the rate at which the capacitive current is changing with time and thus provides an indicator of the steepness of the current slope. High magnitudes of the dI/dt signal indicate rapidly changing current and high current slopes. Since the sense mass used to generate the curves shown in FIGS. 26-29 oscillates about zero displacement and reverses direction at minimum and maximum displacements, the velocity of the sense mass is lowest at its extrema of displacement. At these displacement extrema, the current is also changing less rapidly and thus the dI/dt curve 2902 has a lower magnitude. Using zero-crossings at which the dI/dt curve 2902 has large values results in improved timing resolution and decreased jitter. These zero-crossings occur near the center of the sense mass's range.

FIG. 30 is a graph depicting the displacement offsets of two sense masses as a result of common mode error, according to an illustrative implementation. As shown in graph 3000, two signals 3002 and 3004 may be produced as a result of the oscillation of two sense masses. Signal 3002 may be produced by a TDS structure coupled to one sense mass, while signal 3004 may be produced by a separate TDS structure coupled to a second sense mass. FIG. 30 depicts the affect of common mode error on the signals 3002 and 3004 produced from the sense mass oscillation. As shown in FIG. 30, the common mode error may result in offsets of the two sense masses in the absence of an inertial or external force. These offsets are shown in FIG. 30 at 3006 and 3008, and may correspond to physical offsets of the sense mass oscillations, as shown with reference to FIG. 14. These offsets 3006 and 3008 that result from common mode error cause the zero crossing points of each signal 3002 and 3008 to shift as well, where the time interval between zero crossings 3010, 3012, 3014, 3016, 3018, and 3020 becomes either shorter, as shown at 3024, or longer, as shown at 3022. The shifted time intervals that result from the offsets 3006 and 3008 may cause the multiple degrees of freedom inertial sensor to detect a non zero inertial parameter even in the absence of any inertial forces or perturbations if only a single signal 3002 or 3004 is used to determine the inertial parameter. For any N degree of freedom sensor, there may be N corresponding signals produced from each of the N oscillating sense masses. The signals 3002 and 3004 may be produced from sense masses 1402 and 1404 with reference to FIG. 14, respectively. Thus the offsets may be the result of package deformations of the multiple degrees of freedom inertial sensor.

FIG. 31 is a graph depicting the results of differential sensing on the sensed displacement of a multiple degrees of freedom inertial sensor, according to an illustrative implementation. As shown in graph 3100, the single signal 3102 may result from the linear combination of signals 3002 and 3004 as shown with reference to FIG. 30. Signal 3102 may be the result of subtracting signal 3002 from 3004. As shown in FIG. 31, the offsets 3006 and 3008, which affect each signal path equally, may be removed from the resulting differential signal 3102, such that the differential signal 3102 oscillates about the x axis 3112 corresponding to zero inertial forces or outside perturbations. As can be seen in FIG. 31, the time intervals between zero crossings 3108, 3106, 3104, as shown at 3110, may be regular intervals. The signal 3102 may be produced from the differential sensing of any N degree of freedom sensor, as a result of the linear combination of any N oscillating sense masses. As a result of this differential sensing, the multiple degrees of freedom inertial sensor may correctly detect the absence of outside forces, despite offsets that result in each individual signal produced by each sense mass as a result of package deformations or common mode error.

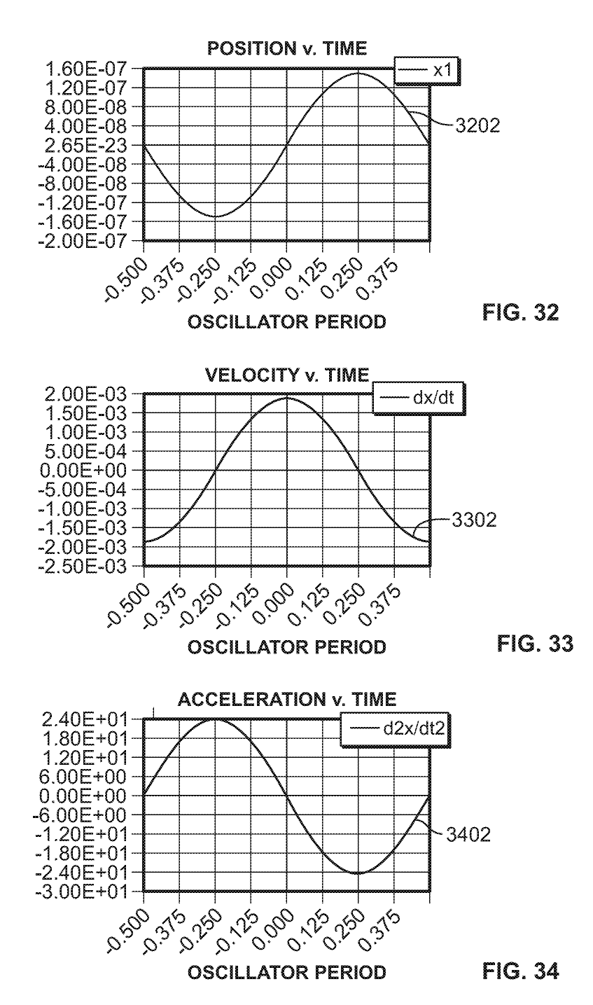

FIG. 32 is a graph representing position of a sense mass relative to time, according to an illustrative implementation. The curve 3202 represents the sinusoidal oscillation of a sense mass about a central anchor. The oscillation shown in FIG. 32 may be the oscillation of any one of the sense masses described herein. The horizontal axis of FIG. 32 represents time normalized by period of the sense mass, meaning that FIG. 32 represents a full period of oscillation of the sense mass. The sense mass shown in FIG. 32 has a resonant frequency of 2 kHz and thus a period of 500 μs.

FIG. 33 is a graph representing velocity of a sense mass relative to time, according to an illustrative implementation. The curve 3302 depicted in FIG. 33 represents velocity of the sinusoidal oscillation of a sense mass about a central anchor. The oscillation shown in FIG. 33 may be the oscillation of any one of the sense masses described herein. The curve 3302 is the first time derivative of the curve 3202 as shown in FIG. 32.

FIG. 34 is a graph representing acceleration of a sense mass relative to time, according to an illustrative implementation. The curve 3402 represents acceleration of the sinusoidal oscillation of a sense mass about a central anchor. The oscillation shown in FIG. 34 may be the oscillation of any one of the sense masses described herein. The curve 3402 is the first time derivative of the curve 3302 as shown in FIG. 33, and the second time derivative of the curve 3202 as shown in FIG. 32.

FIGS. 32-34 show the relationship between the displacement of a sense mass as shown in FIG. 32 and the inertial parameters velocity and acceleration as shown in FIG. 33 and FIG. 34 respectively. The curves 3202, 3302 and 3402 may represent the oscillation of a sense mass in the absence of external perturbations other than the drive force produced by drive structures to actuate the sense mass. As can be seen, local extrema of one signal may translate to a zero-crossing in another.

FIG. 35 is a graph representing capacitance relative to angular position of a sense mass, according to an illustrative implementation. FIG. 35 represents changes in capacitance of a first and second electrode as a sense mass oscillates about a central anchor. FIG. 35 may represent an output signal produced by the electrodes 1204a and 1204b as depicted in FIG. 12. The signals 3502 and 3504 may be produced in response to the motion depicted in any of the FIG. 4, 5, 7 or 8. As shown in FIG. 12, because the electrode 1204a located at the larger radius 1212 experiences a larger change in position than the electrode 1204b located at the smaller radius 1210 for the same angular displacement, the electrode 1204a experiences a larger change in capacitance as well. Thus curve 3502 shows the change in capacitance of electrode 1204a, while curve 3504 shows the change in capacitance of electrode 1204b. At the angular positions 3508 and 3506, the capacitance of the two electrodes is equal. As depicted in FIG. 35, these angular positions are approximately +/−0.124°. The magnitudes of capacitance curves 3502 and 3506 may vary due to applied bias, rotational mass velocity, temperature, electronic drift, and other such factors, but the physical, angular positions at which the capacitances equal each other are defined by the geometry of the sense mass 1208 and position of the electrodes 1204a and 1204b, and will therefore be invariant under any changes in these outside factors. Thus using differential signal processing, where the curve 3502 and 3504 may be linearly combined and subtracted from each other, the locations 3508 and 3506 will correspond to positions at which the differential in capacitance is equal to zero. As the sense mass oscillates, the differential capacitance can be measured and the times at which the sense mass passes these predetermined angular positions can therefore be determined.

FIG. 36 is a graph representing capacitive slope relative to angular position of a sense mass, according to an illustrative implementation. The curves 3602 and 3604 represent changes in the capacitive slope of the capacitance produced by first and second electrodes as a sense mass oscillates about a central anchor. The electrodes may be the electrodes 1204a and 1204b as depicted with reference to FIG. 12. The curve 3602 may correspond to the capacitive slope of electrode 1204a, while the curve 3604 may correspond to the capacitive slope of electrode 1204b. The curve 3602 is the first spatial derivative of curve 3502, and the curve 3604 is the first spatial derivative of curve 3504 as depicted with reference to FIG. 35.

FIG. 37 is a graph representing capacitive curvature relative to angular position of a sense mass, according to an illustrative implementation. The curves 3702 and 3704 represent changes in the capacitive curvature produced by first and second electrodes as a sense mass oscillates about a central anchor. The electrodes may be electrodes 1204a and 1204b as depicted with reference to FIG. 12. The curve 3702 may correspond to electrode 1204a, while the curve 3704 may correspond to electrode 1204b. The curve 3704 is the first spatial derivative of curve 3604, while the curve 3702 is the first spatial derivative of curve 3602 as depicted with reference to FIG. 36. The curve 3702 is the second spatial derivative of the curve 3502, while the curve 3704 is the second spatial derivative of curve 3504, as depicted in with reference to FIG. 35.

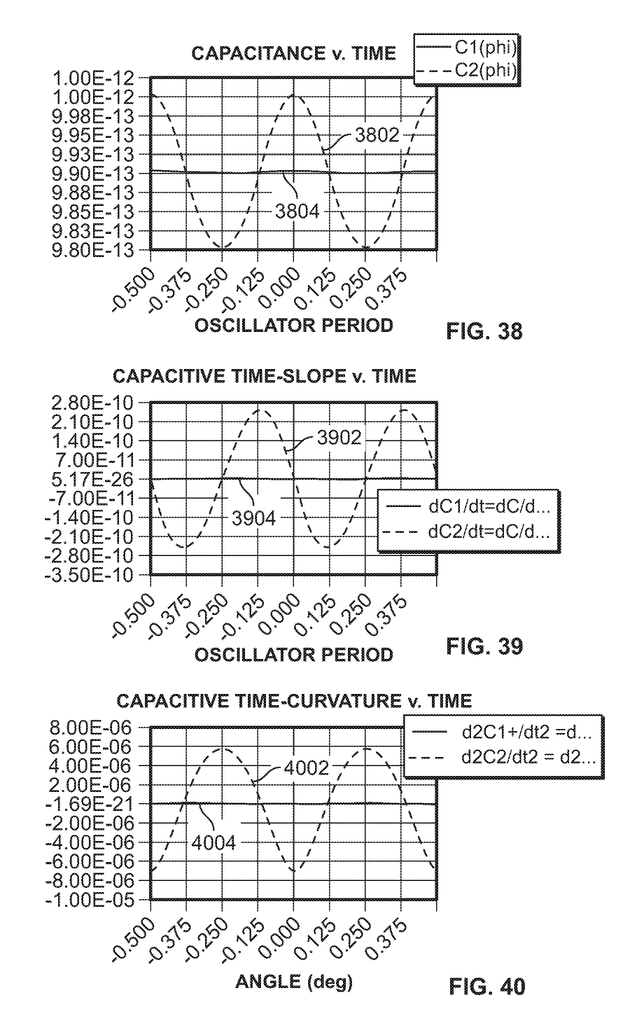

FIG. 38 is a graph representing capacitance relative to time and produced in response to oscillations of a sense mass, according to an illustrative implementation. The curves 3802 and 3804 represent changes in the capacitive curvature produced by first and second electrodes as a sense mass oscillates about a central anchor. The electrodes may be electrodes 1204a and 1204b as depicted with reference to FIG. 12. The curve 3802 may be produced by the electrode 1204a, while the curve 3804 may be produced by the electrode 1204b. The capacitance can be measured by one or more capacitance-to-voltage (C-to-V) converters. A C-to-V converter can be a charge amplifier, a switch capacitor, a bridge with a general impedance converter (GIC), or another analog front end that produces a voltage corresponding to a measured charge or capacitance.

FIG. 39 is a graph representing capacitive slope relative to time and produced in response to oscillations of a sense mass, according to an illustrative implementation. The curves 3902 and 3904 represent changes in the capacitive slope produced by first and second electrodes as a sense mass oscillates about a central anchor. The electrodes may be electrodes 1204a and 1204b as depicted with reference to FIG. 12. The curve 3902 may be produced by the electrode 1204a, while the curve 3904 may be produced by the electrode 1204b. The curve 3902 is the first time derivative of curve 3802, while the curve 3904 is the first time derivative of curve 3804 as shown in FIG. 38. The curves 3902 and 3904 can be measured by an analog front end that measures current, such as a transimpedance amplifier (TIA).

FIG. 40 is a graph representing capacitive curvature relative to time and produced in response to oscillations of a sense mass, according to an illustrative implementation. The curves 4002 and 4004 represent changes in the capacitive curvature produced by first and second electrodes as a sense mass oscillates about a central anchor. The electrodes may be electrodes 1204a and 1204b as depicted with reference to FIG. 12. The curve 4002 may be produced by the electrode 1204a, while the curve 4004 may be produced by the electrode 1204b. The curve 4002 is the first time derivative of curve 3902, while the curve 4004 is the first time derivative of curve 3904 as shown in FIG. 39. The curve 4002 is the second time derivative of curve 3802, while the curve 4002 is the second time derivative of curve 3802. As the second time derivatives, curves 4002 and 4004 represent the rates at which the capacitive slopes change.

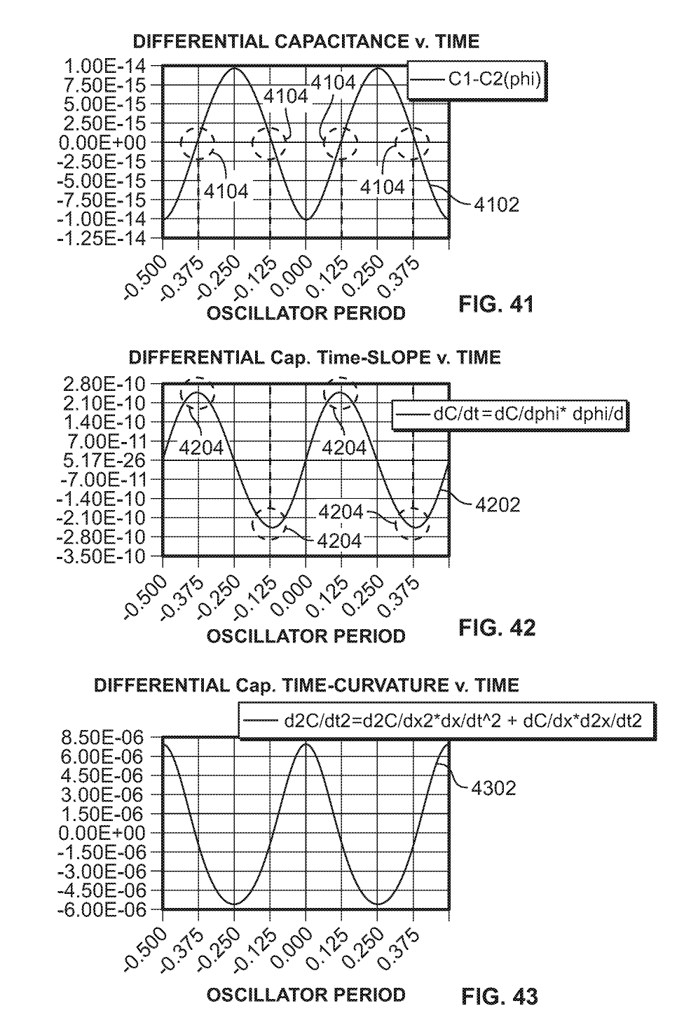

FIG. 41 is a graph representing differential capacitance relative to time and produced in response to oscillations of a sense mass, according to an illustrative implementation. The curve 4102 is the difference of the curves 3802 and 3804 as shown with reference to FIG. 38. The curve 4102 can be obtained by measuring the difference of capacitance between the first and second electrodes. The electrodes may be electrodes 1204a and 1204b as depicted with reference to FIG. 12. This may be measured by a differential amplifier, or the capacitance curves 3802 and 3804 can be measured separately and the difference obtained via analog or digital signal processing. The time at which the curve 4102 equals zero are the zero-crossing times shown at 4104. These zero-crossing times are the times at which the capacitances of the first and second electrodes are equal. These zero-crossing times correspond to the predetermined angular positions at which the two electrodes have the same capacitance. The times shown at 4104 may be detected via analog means and can be converted to a digital signal by a time-to-digital converter (TDC). The digital signal produced by the TDC can be a binary signal that toggles between high and low signals when the zero-crossings 4104 are detected. By measuring the times at which zero-crossings 4104 occur, the time at which the sense mass is at a predetermined angular position may also be determined.

FIG. 42 is a graph representing differential capacitive slope relative to time and produced in response to oscillations of a sense mass, according to an illustrative implementation. The curve 4202 represents changes in the slope of differential capacitance between a first and second electrode as a sense mass oscillates about a central anchor. The electrodes may be electrodes 1204a and 1204b as depicted with reference to FIG. 12. The curve 4202 can be obtained by a differential measurement of current from the first and second electrodes. Alternatively, the curve 4202 can be obtained by differentiating the curve 4102 as shown in FIG. 41 using digital signal processing. The extrema 4204 of the curve 4202 correspond to the zero-crossings of the curve 4102 as shown in FIG. 41. Thus, the zero-crossings 4104 can be measured by peak detection of the curve 4202. This peak detection can be performed via analog or digital means. Furthermore, the magnitude of the capacitive slope curve depicted in FIG. 4202 corresponds to the steepness of the curve 4102. A steeper slope at zero-crossing times results in lower timing uncertainty of the zero-crossing time measurements.

FIG. 43 is a graph representing differential capacitive curvature relative to time and produced in response to oscillations of a sense mass, according to an illustrative implementation. The curve 4302 represents changes in curvature of differential capacitance between two electrodes as a sense mass oscillates about a central anchor. The electrodes may be electrodes 1204a and 1204b as depicted with reference to FIG. 12. The curve 4302 can be obtained by differentiating the curve 4202 as shown in FIG. 42 using analog or digital signal processing. The magnitude of the curvature curve 4302 represents the steepness of the slope of the curve 4202. A higher magnitude of curvature will result in lower timing uncertainty of peak detection measurements of the curve 4302.

The zero-crossing times determined as described with respect to FIG. 35-43 can be used to determine time periods for use in a cosine method describe with respect to FIG. 12. Thus, by using the cosine method and zero-crossing times corresponding to predetermined physical positions of a sense mass, the amplitude, frequency, and offset of the sense mass can be determined. Inertial parameters of the multiple degrees of freedom sense or can be determined from the amplitude, frequency and offset of its sense masses.

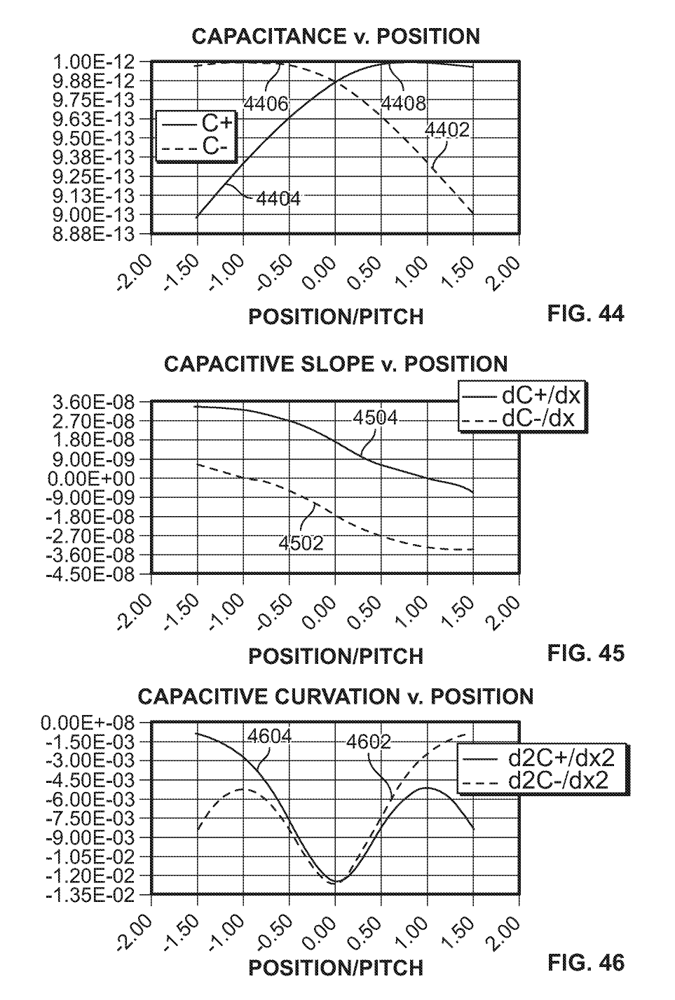

FIG. 44 is a graph representing capacitance relative to the vertical position of a sense mass, according to an illustrative implementation. FIG. 44 represents changes in capacitance of a first and second electrode as a sense mass oscillates about a central anchor. FIG. 44 may represent an output signal produced by the electrodes 1306a and 1306b as depicted in FIG. 13. The oscillation of the sense mass may entail raising and lowering in only the vertical direction as shown in FIG. 13. The signals 4402 and 4404 may be produced in response to the motion of a sense mass as shown in FIG. 13. Because the electrodes 1306a and 1306b have different heights (as shown at the gap 1310 in FIG. 13) and are thus aligned with the stationary electrode comprising the sense mass 1312 at different vertical positions, the capacitive curves 4402 and 4404 have local extrema 4406 and 4408 at different vertical positions. The local maximum of each curve corresponds to the vertical position at which the moving electrode positioned on the oscillating sense mass is aligned with the stationary electrode. The vertical position corresponding to the local maximum depends only on the geometry of the stationary electrodes and the moving sense mass. Thus, although the magnitude of capacitance may vary due to bias, sense mass velocity, temperature, electronic drift, or other factors, the vertical position in which the maximum of capacitance occurs for each electrode remains constant. By determining times at which these maxima 4406 and 4408 occur, the times at which the sense mass is in the corresponding vertical position may be determined.

FIG. 45 is a graph representing capacitive slope relative to the vertical position of a sense mass, according to an illustrative implementation. The curves 4504 and 4502 represent changes in the capacitive slope of the first and second electrodes as the sense mass oscillates about a central anchor. The electrodes may be 1306a and 1306b as shown in FIG. 13. The curve 4504 may be the first spatial derivative of the curve 4404, while the curve 4502 may be the first spatial derivative of curve 4402, as shown in FIG. 44.

FIG. 46 is a graph representing capacitive curvature relative to the vertical position of a sense mass, according to an illustrative implementation. The curves 4602 and 4604 represent changes in the capacitive curvature of the first and second electrodes as the sense mass oscillates about a central anchor. The electrodes may be 1306a and 1306b as shown in FIG. 13. The curve 4602 may be the first spatial derivative of curve 4502, while the curve 4604 may be the first spatial derivative of curve 4504, as shown in FIG. 45.

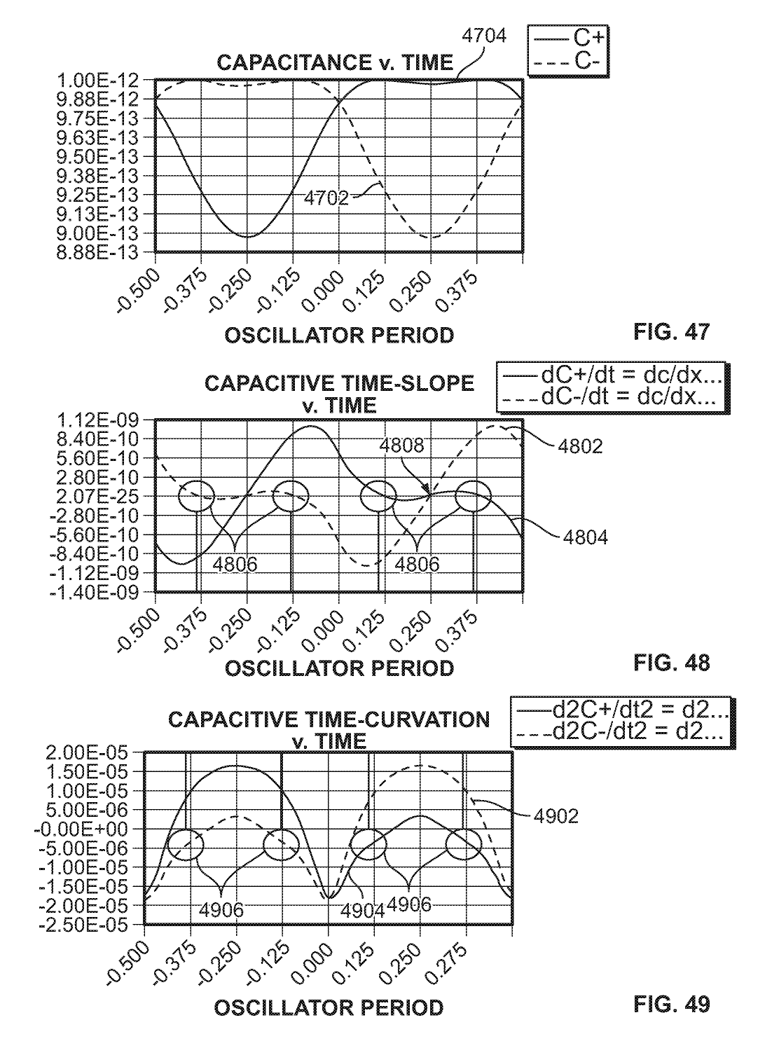

FIG. 47 is a graph representing capacitance relative to time and produced in response to oscillations of a sense mass, according to an illustrative implementation. The curves 4702 and 4704 represent changes in capacitance of the first electrode and the second electrode as a sense mass oscillates about a central anchor. The electrodes may be 1306a and 1306b as shown in FIG. 13. The times at which the capacitance experiences a local extremum correspond to either times of zero velocity or times at which the moving sense mass is aligned with the stationary electrode, causing a local maximum in capacitance.

FIG. 48 is a graph representing capacitive slope relative to time and produced in response to oscillations of a sense mass, according to an illustrative implementation. The curves 4802 and 4804 represent changes in capacitance of the first electrode and the second electrode as a sense mass oscillates about a central anchor. The electrodes may be 1306a and 1306b as shown in FIG. 13. The curve 4802 is the first time derivative of curve 4702, while the curve 4804 is the first time derivative of curve 4704, as shown in FIG. 47. Thus the curves 4802 and 4804 represent the rates at which capacitance changes. The capacitive slopes 4802 and 4804 can be measured by an analog front end, such as a TIA, that measures current. The times at which the capacitive slope is equal to zero correspond to times at which the capacitance is at a local extremum or inflection point. These times may correspond to times at which a sense mass is at zero velocity, or times at which the sense mass is aligned with the stationary electrode, causing a local maximum in capacitance. By determining times at which the capacitive slope crosses zero (or zero-crossing times), the corresponding times at which the sense mass is at a predetermined position with respect to the stationary electrode can be determined.

FIG. 49 is a graph representing capacitive curvature relative to time and produced in response to oscillations of a sense mass, according to an illustrative implementation. The curves 4902 and 4904 represent changes in the capacitive curvature of the first and second electrodes as a sense mass oscillates about a central anchor. The curve 4902 is the first time derivative of the curve 4802, while the curve 4904 is the first time derivative of the curve 4804, as shown in FIG. 48.

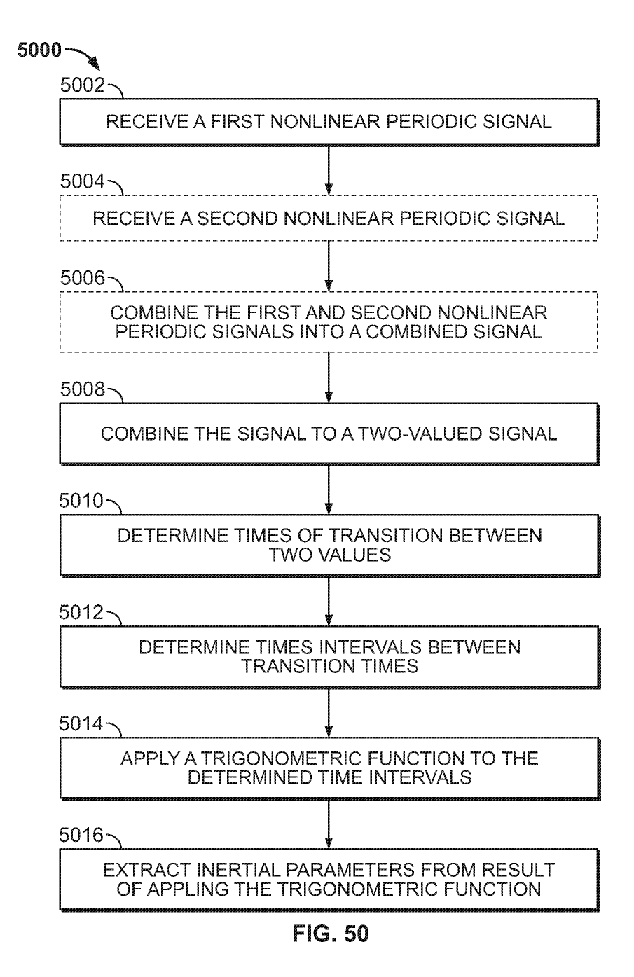

FIG. 50 depicts a flow chart of a method for extracting inertial parameters from a nonlinear periodic signal, according to an illustrative implementation. At 5002, a first nonlinear periodic signal is received. At 5004, a second nonlinear periodic signal is optionally received. The first nonlinear periodic signal and the optional second nonlinear periodic signal can be generated by any of the sensing structures described herein, such as structures depicted in FIGS. 1-16, 18 and 20.

At 5006, optionally, the first and second nonlinear periodic signals are combined into a combined signal. This can be accomplished by the element 1706. If the steps 5004 and 5006 are omitted, the method 5000 proceeds from 5002 directly to 5008.

At 5008, the signal is converted to a two-valued signal. The two-valued signal can be a signal that has substantially only two values, but may transition quickly between the two values. This two-valued signal can be a digital signal such as that output from a digital circuit element. In some examples, the two-valued signal is produced by amplifying the combined signal or one of the first and second nonlinear signals using a high-gain amplifier. This technique can be referred to as “amplifying to the rails.” The two-valued signal may be converted by an element such as the element 1706, and can be one or more of the signals 1712 or 2336. The two-valued signal can be determined based on a threshold such that if the combined, first, or second signal is above the threshold, the two-valued signal takes on a first value and if below the threshold, the two-valued signal takes on a second value.

At 5010, times of transitions between the two values of the two-valued signal are determined. In some examples, these times can be determined using a time-to-digital converter (TDC) such as one or both of the elements 2514 and 3616. The time intervals determined in this way can be one or more of the intervals 2516, 2832, 2834, 3040, and 3042.

At 5014, a trigonometric function is applied to the determined time intervals. The trigonometric function can be a sine function, a cosine function, a tangent function, a cotangent function, a secant function, and a cosecant function. The trigonometric function can also be one or more of the inverse trigonometric functions such as the arcsine, the arccosine, the arctangent, the arccotangent, the arcsecant, and the arccosecant functions. Applying the trigonometric function can include applying a trigonometric function to an argument that is based on the determined time intervals.

At 5016, inertial parameters are extracted from the result of applying the trigonometric function. Extracting the inertial parameters can include curve fitting and computing derivatives of the result. The inertial parameters can one or more of sensor acceleration, sensor velocity, sensor displacement, sensor rotation rate, sensor rotational acceleration and higher order derivatives of linear or rotational acceleration, such as jerk, snap, crackle, and pop.

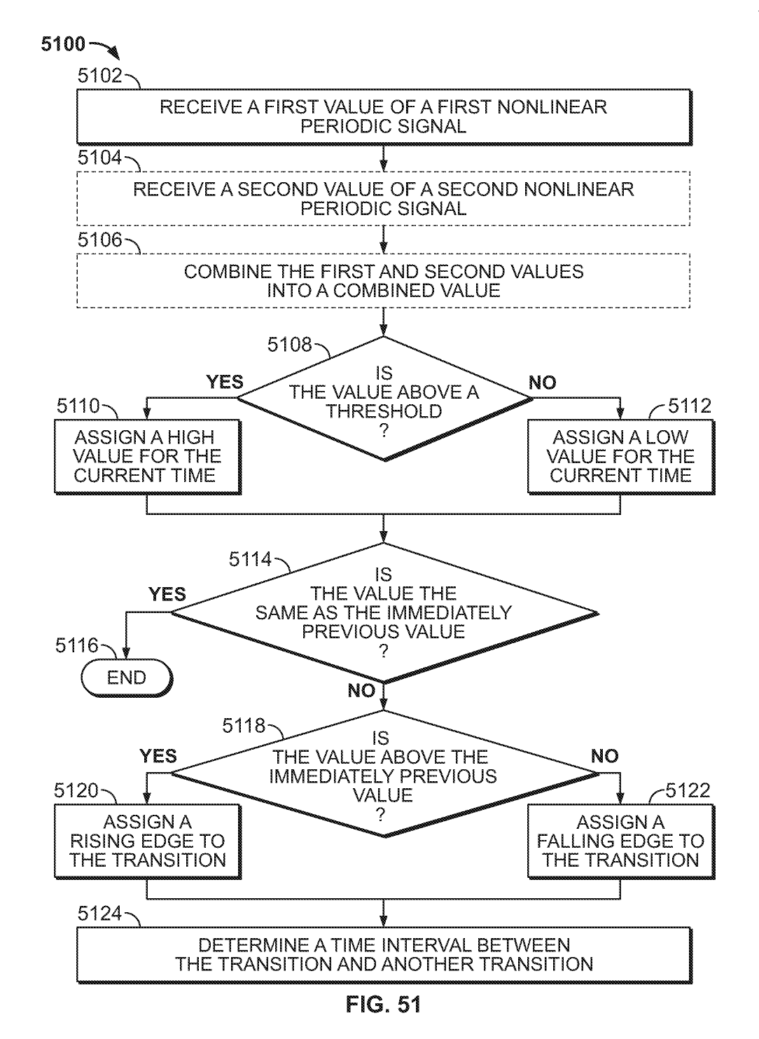

FIG. 51 depicts a flow chart of a method for determining transition times between two values based on a nonlinear periodic signal, according to an illustrative implementation. The method 5100 can be used to perform one or more of the steps 5002, 5004, 5006, 5008, and 5010 of the method 5000.

At 5102, a first value of a first nonlinear of a nonlinear periodic signal is received. At 5104, a second value of a second nonlinear periodic signal is optionally received. The first and second values are values of the first and second signals at particular moments in time, and can be analog or digital values. The first and second nonlinear periodic signals of the method 5100 can be the same as the first and second nonlinear periodic signals of the method 5000.

At 5106, the first and second values are optionally combined into a combined value. The values may be combined using the element 1706. Combining may include summing the values, taking a difference of the values, multiplying the values, or dividing the values. If the optional steps 5104 and 5106 are omitted, the method 5100 proceeds from 5102 directly to 5108.

At 5108, the first value or the combined value is compared to a threshold. If the value is above the threshold, the method 5100 proceeds to 5110.

At 5110, a high value is assigned for the current time. If the value is not above the threshold, the method 5100 proceeds to 5112. At 5112, a low value is assigned for the current time. The steps 5108, 5110 and 5112 can be used to generate a two-valued signal having high and low values from an input signal. The two-valued signal of the method 5100 can be the same as the signal of the method 5000.

At 5114, the value of the signal for the current time is compared to a value of the signal for an immediately previous time. If the two values are the same, the method 5100 proceeds to 5116 where the method 5100 terminates. If the two values are not the same, a transition has occurred and the method proceeds to 5118.

At 5118, the sense of the transition (whether the transition is a rising edge or a falling edge) is determined. If the value for the current time is greater than the value for the previous time, a rising edge is assigned to the transition.

If the value for the current time is not above the value for the previous time, the method 5100 proceeds to 5122. At 5122, a falling edge is assigned to the transition. Thus, times having transitions are detected and classified as having either rising or falling edges. At 5124, a time interval is determined between the transition and another transition. Time intervals between these transition times can be determined by obtaining a difference in time values between times of transition.

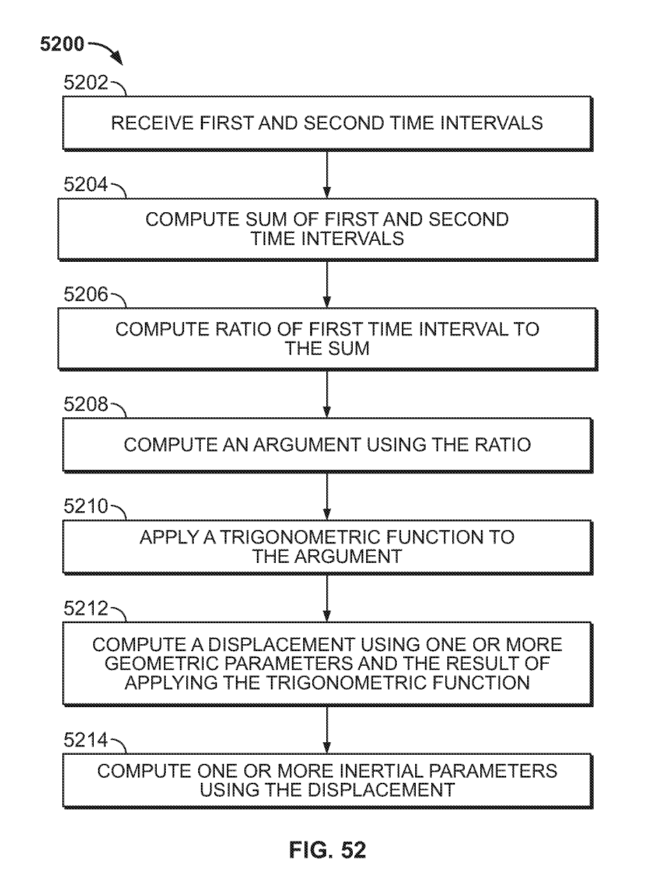

FIG. 52 depicts a flow chart of a method for computing inertial parameters from time intervals, according to an illustrative implementation. The method 5200 can be used to perform one or more of the steps 5014 and 5016 of the method 5000.

At 5202, first and second time intervals are received. The first and second time intervals can be determined using the method 5100.

At 5204, a sum of the first and second time intervals is computed. The sum can be the measured period as described by equations 6 and 7. At 5206, a ratio of the first time interval to the sum is computed. The ratio can be one or more of the ratios forming part of the arguments of the cosine functions in equation 5.

At 5208, an argument is computed using the ratio. The argument can be one or more of the arguments of the cosine functions of equation 5.

At 5210, a trigonometric function is applied to the argument. The trigonometric function can be any of the trigonometric functions described with respect to step 5004 of the method 5000.

At 5212, a displacement is computed using one or more geometric parameters and the result of applying the trigonometric function. The displacement can be computed using equation 5. Computing displacement can involve computing more than one trigonometric function, and arguments other than the computed argument of 5208 can be included as arguments of some of the trigonometric functions.

At 5214, one or more inertial parameters are computed using the displacement. The inertial parameters computed can be any of the inertial parameters described with respect to step 5016 of the method 5000. Inertial parameters can be computed by obtaining one or more derivatives of the displacement with respect to time. Inertial parameters may be extracted using an offset of the computed displacement to determine an external acceleration. In this way, inertial parameters are computed from time intervals.

The systems described herein can be fabricated using MEMS and microelectronics fabrication processes such as lithography, deposition, and etching. The features of the MEMS structure are patterned with lithography and selected portions are removed through etching. Such etching can include deep reactive ion etching (DRIE) and wet etching. In some examples, one or more intermediate metal, semiconducting, and/or insulating layers are deposited. The base wafer can be a doped semiconductor such as silicon. In some examples, ion implantation can be used to increase doping levels in regions defined by lithography. The spring systems can be defined in a substrate silicon wafer, which is then bonded to top and bottom cap wafers, also made of silicon. Encasing the spring systems in this manner allows the volume surrounding the mass to be evacuated. In some examples, a getter material such as titanium is deposited within the evacuated volume to maintain a low pressure throughout the lifetime of the device. This low pressure enhances the quality factor of the resonator. From the MEMS structure, conducting traces are deposited using metal deposition techniques such as sputtering or physical vapor deposition (PVD). These conducting traces electrically connect active areas of the MEMS structure to microelectronic circuits. Similar conducting traces can be used to electrically connect the microelectronic circuits to each other. The fabricated MEMS and microelectronic structures can be packaged using semiconductor packaging techniques including wire bonding and flip-chip packaging.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, flash memory (e.g., AND/NOR, NAND), memrister memory, and PSRAM.

As used herein, the term “processor” is meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, secure microprocessors, and ASICs). Such digital processors may be contained on a single unitary integrated circuit die, or distributed across multiple components.

From the above description of the system it is manifest that various techniques may be used for implementing the concepts of the system without departing from its scope. In some examples, any of the circuits described herein may be implemented as a printed circuit with no moving parts. Further, various features of the system may be implemented as software routines or instructions to be executed on a processing device (e.g. a general purpose processor, an ASIC, an FPGA, etc.) The described embodiments are to be considered in all respects as illustrative and not restrictive. It should also be understood that the system is not limited to the particular examples described herein, but can be implemented in other examples without departing from the scope of the claims.

Similarly, while operations are depicted in the drawings in a particular order, this should not be understood as requiring that such operations be performed in the particular order shown or in sequential order, or that all illustrated operations be performed, to achieve desirable results.

What is claimed is:

1. An inertial device having multiple degrees of freedom for determining an inertial parameter, the inertial device comprising:
a first sense mass with a first degree of freedom;
a second sense mass mechanically coupled to the first sense mass and with a second degree of freedom;
a first time domain switch coupled to the first sense mass, and a second time domain switch coupled to the second sense mass;
a drive structure configured to oscillate the first sense mass and the second sense mass in a differential frequency mode, wherein the first time domain switch and the second time domain switch each produce an electrical signal in response to oscillations of the first sense mass and the second sense mass; and
a processor in signal communication with the first time domain switch and the second time domain switch, and configured to determine an inertial parameter based in part on time intervals produced by the electrical signal.

2. The inertial device of claim 1, wherein as the first sense mass and the second sense mass oscillate in the differential frequency mode, the first time domain switch and the second time domain switch produce a differential signal.

3. The inertial device of claim 2, the inertial device further comprising:
coupling springs mechanically coupled to the first sense mass and to the second sense mass;
anchoring springs independently mechanically coupled to each of the first sense mass and the second sense mass and a central anchoring structure, and wherein the central anchoring structure is rigidly coupled to a support structure.

4. The inertial device of claim 3, wherein the inertial parameter is determined using a spring constant of the respective anchoring springs and a spring constant of the coupling springs to reduce the frequency of the differential frequency mode.

5. The inertial device of claim 4, wherein a common mode frequency component of the electrical signal produced by the first time domain switch and the second time domain switch is substantially eliminated from the differential signal.

6. The inertial device of claim 5, wherein the first degree of freedom and the second degree of freedom are in a vertical dimension.

7. The inertial device of claim 6, wherein the inertial parameter is acceleration in the vertical dimension.

8. The inertial device of claim 7, wherein the first time domain switch further comprises:
a first electrode at a first radial distance of the first sense mass;
a second electrode at a second radial distance of the first sense mass; and
as the first sense mass and the second sense mass oscillate at the differential frequency mode, the processor is configured to detect a differential in capacitance of the first electrode and the second electrode.

9. The inertial device of claim 8, wherein the time intervals are based in part on the times at which the differential in capacitance is equal to zero.

10. The inertial device of claim 9, wherein the first sense mass and the second sense mass raise and lower in the vertical dimension above the support structure.

11. The inertial device of claim 9, wherein the first sense mass and the second sense mass oscillate in vertical torsional rotation about the central anchoring structure.

12. A method of determining an inertial parameter using multiple degrees of freedom, the method comprising:
oscillating a first sense mass in a first degree of freedom;
oscillating a second sense mass mechanically coupled to the first sense mass and with a second degree of freedom;
coupling a first time domain switch to the first sense mass, and a second time domain switch to the second sense mass;
producing an electrical signal in response to oscillations of the first sense mass and the second sense mass from each of the first time domain switch and the second time domain switch, and wherein a drive structure oscillates the first sense mass and the second sense mass at a differential frequency mode; and
determining an inertial parameter based in part on time intervals produced by the electrical signal.

13. The method of claim 12, further comprising producing a differential signal from the first sense mass and the second sense mass as the first sense mass and the second sense mass oscillate in the differential frequency mode.

14. The method of claim 13, further comprising:
mechanically coupling the first sense mass to the second sense mass with coupling springs;
mechanically coupling each of the first sense mass and the second sense mass to a central anchoring structure with anchoring springs, and wherein the central anchoring structure is rigidly coupled to a support structure.

15. The method of claim 14, further comprising determining the inertial parameter using a spring constant of the respective anchoring springs and a spring constant of the coupling springs and reducing the frequency of the differential frequency mode.

16. The method of claim 15, further comprising eliminating a common mode frequency component of the electrical signal produced by the first time domain switch and the second time domain switch from the differential signal.

17. The method of claim 16, wherein oscillating the first sense mass in the first degree of freedom and oscillating the second sense mass mechanically coupled to the first sense mass in the second degree of freedom further comprises:
wherein the first degree of freedom and the second degree of freedom are in a vertical dimension.

18. The method of claim 17, wherein determining the inertial parameter based in part on time intervals produced by the electrical signal further comprises wherein the inertial parameter is acceleration in the vertical dimension.

19. The method of claim 18, wherein producing the electrical signal in response to oscillations of the first sense mass from the first time domain switch further comprises:
generating a capacitance from a first electrode at a first radial distance of the first sense mass;
generating a capacitance from a second electrode at a second radial distance of the first sense mass; and
as the first sense mass and the second sense mass oscillate at the differential frequency mode, detecting a differential in capacitance of the first electrode and the second electrode.

20. The method of claim 19, wherein determining the inertial parameter based in part on time intervals produced by the electrical signal further comprises wherein the time intervals are based in part on a plurality of times at which the differential in capacitance is equal to zero.

21. The method of claim 20, wherein oscillating the first sense mass in the first degree of freedom and oscillating the second sense mass mechanically coupled to the first sense mass in the second degree of freedom further comprises:
raising and lowering the first sense mass and the second sense mass in the vertical dimension above the support structure.

22. The method of claim 20, wherein oscillating the first sense mass in the first degree of freedom and oscillating the second sense mass mechanically coupled to the first sense mass in the second degree of freedom further comprises:
oscillating the first sense mass in vertical torsional rotation about the central anchoring structure.

23. An inertial device having multiple degrees of freedom for determining an inertial parameter, the inertial device comprising:
a first sense mass with a first degree of freedom;
a second sense mass mechanically coupled to the first sense mass and with a second degree of freedom;
a first time domain switch coupled to the first sense mass, and a second time domain switch coupled to the second sense mass;
a drive structure configured to oscillate the first sense mass and the second sense mass in a differential frequency mode, wherein the first time domain switch and the second time domain switch each produce an electrical signal in response to oscillations of the first sense mass and the second sense mass; and
a processor in signal communication with the first time domain switch and the second time domain switch, and configured to determine an inertial parameter based in part on time intervals produced by the electrical signal.

24. The inertial device of claim 23, wherein as the first sense mass and the second sense mass oscillate in the differential frequency mode, the first time domain switch and the second time domain switch produce a differential signal.

25. The inertial device of claim 24, the inertial device further comprising:
coupling springs mechanically coupled to the first sense mass and to the second sense mass;
anchoring springs independently mechanically coupled to each of the first sense mass and the second sense mass and a central anchoring structure, and wherein the central anchoring structure is rigidly coupled to a support structure.

26. The inertial device of claim 25, wherein the inertial parameter is determined using a spring constant of the respective anchoring springs and a spring constant of the coupling springs to reduce the frequency of the differential frequency mode.

27. The inertial device of claim 26, wherein a common mode frequency component of the electrical signal produced by the first time domain switch and the second time domain switch is substantially eliminated from the differential signal.

28. The inertial device of claim 27, wherein the first degree of freedom and the second degree of freedom are in a horizontal dimension.

29. The inertial device of claim 28, wherein the inertial parameter is acceleration in the horizontal dimension.

30. The inertial device of claim 29, wherein the first sense mass is mechanically coupled to the second sense mass with a frame, and wherein the frame oscillates in differential motion with the first sense mass and the second sense mass in-plane with the horizontal dimension.

31. The inertial device of claim 30, wherein the first time domain switch comprises a first set of capacitive teeth that produce a first capacitive current, and the second time domain switch comprises a second set of capacitive teeth that produce a second capacitive current, and wherein the first capacitive current is out of phase with the second capacitive current.

32. The inertial device of claim 31, wherein the differential signal is a linear combination of the first capacitive current and the second capacitive current.

33. A method of determining an inertial parameter using multiple degrees of freedom, the method comprising:
oscillating a first sense mass in a first degree of freedom;
oscillating a second sense mass mechanically coupled to the first sense mass and with a second degree of freedom;
coupling a first time domain switch to the first sense mass, and a second time domain switch to the second sense mass;
producing an electrical signal in response to oscillations of the first sense mass and the second sense mass from each of the first time domain switch and the second time domain switch, and wherein a drive structure oscillates the first sense mass and the second sense mass at a differential frequency mode; and
determining an inertial parameter based in part on time intervals produced by the electrical signal.

34. The method of claim 33, further comprising producing a differential signal from the first sense mass and the second sense mass as the first sense mass and the second sense mass oscillate in the differential frequency mode.

35. The method of claim 34, further comprising:
mechanically coupling the first sense mass to the second sense mass with coupling springs;
mechanically coupling each of the first sense mass and the second sense mass to a central anchoring structure with anchoring springs, and wherein the central anchoring structure is rigidly coupled to a support structure.

36. The method of claim 35, further comprising determining the inertial parameter using a spring constant of the respective anchoring springs and a spring constant of the coupling springs and reducing the frequency of the differential frequency mode.

37. The method of claim 36, further comprising eliminating a common mode frequency component of the electrical signal produced by the first time domain switch and the second time domain switch from the differential signal.

38. The method of claim 37, wherein oscillating the first sense mass in the first degree of freedom and oscillating the second sense mass mechanically coupled to the first sense mass in the second degree of freedom further comprises:
wherein the first degree of freedom and the second degree of freedom are in a horizontal dimension.

39. The method of claim 38, wherein determining the inertial parameter based in part on time intervals produced by the electrical signal further comprises wherein the inertial parameter is acceleration in the horizontal dimension.

40. The method of claim 39, further comprising:
mechanically coupling the first sense mass to the second sense mass with a frame, and wherein the frame oscillates in differential motion with the first sense mass and the second sense mass in-plane with the horizontal dimension.

41. The method of claim 40, further comprising:
producing a first capacitive current from the first time domain switch comprising a first set of capacitive teeth;
producing a second capacitive current from the second time domain switch comprising a second set of capacitive teeth; and
wherein the first capacitive current is out of phase with the second capacitive current.

42. The method of claim 41, wherein determining the inertial parameter based in part on time intervals produced by the electrical signal further comprises:
determining a linear combination of the first capacitive current and the second capacitive current.
